(19) United States
(12) Patent Application Publication
(10) Pub. No.: US 2022/0258410 A1
(43) Pub. Date: Aug. 18, 2022

(54) 3D-PRINTING METHODS AND SYSTEMS

(71) Applicant: BOSTIK SA, Colombes (FR)

(72) Inventors: Meritxell FERRE ROMEU, Bellaterra, Barcelona (ES); Patxi GARRA, Bellaterra, Barcelona (ES); Ciaran MCARDLE, Bellaterra, Barcelona (ES); Laura CAMPOS BELLOSTAS, Bellaterra, Barcelona (ES); Esmael AHBITI LAARAB, Bellaterra, Barcelona (ES); Mariona VICENC I ROMAGUERA, Bellaterra, Barcelona (ES)

(21) Appl. No.: 17/597,693

(22) PCT Filed: Jul. 20, 2020
(86) PCT No.: PCT/EP2020/070423

§ 371 Date: Jan. 18, 2022

(30) Foreign Application Priority Data
Jul. 18, 2019 (EP) 19305949.0

(51) Int. Cl. B29C 64/129; B29C 64/282; B33Y 10/00; B33Y 30/00; B33Y 70/00

(52) U.S. Cl. CPC B29C 64/129; B29C 64/282; B33Y 10/00; B29K 2033/08; B33Y 70/00; B29K 2049/00; B33Y 30/00

(57) ABSTRACT

The present invention belongs to the field of three-dimensional printing methods. It relates to a method for printing a three-dimensional article, to a system thereof, to the use thereof and to a three-dimensional printed article manufactured therewith. The present invention relies on the use of a liquid resin comprising cyanoacrylate-based monomers and on the use of acidic inhibitors.

### TECHNICAL FIELD

The present invention belongs to the field of three-dimensional (3D) printing. It relates to methods for printing a three-dimensional article, to a system thereof, the use thereof, and to a 3D printed article manufactured therewith. The present invention relies on the use of liquid resins comprising cyanoacrylates.

### TECHNICAL BACKGROUND

Three-dimensional printing—also known as additive manufacturing processes—are methods of printing three-dimensional articles. These articles may be obtained from photosensitive powder, liquid or molten starting materials. Particularly, they may be obtained from resins such as monomers, being photopolymerizable at room temperature.

Different methods have been developed, including those based on the layer-by-layer approach.

The layer-by-layer approach can be implemented via a “top down” “point-by-point” serial processing method, e.g. fused deposition modeling, selective laser sintering, etc.

Alternatively, the layer-by-layer approach can be implemented via a “bottom-up” “slice-at-a-time” serial processing method, in which a layer of resin is photopolymerized using for example a digital light projector or a LCD mask combined with a light source, or by a stereolithographic method. A suitable device comprises at least a tank, a movable platform and a light source. The base of the tank comprises a bottom wall, which is optically transparent, hereby forming a window. The transparent window may be a durable transparent plastic film. The top surface of the transparent window, within the tank, may be a non-stick surface. The light source may be a digital light projector, a LED light source or any other suitable light source. When a LED light source is used, a mask may be interposed between the light source and the base of the tank. In this method, the light source is located below the tank, and emits light being transmitted through the transparent window. The platform comprises a bottom flat surface, facing the transparent window, and being generally positioned in a X-Y horizontal plane. The platform is movably mounted in the tank and may move up and down along a Z vertical axis.

A bath of liquid polymerizable resin is contained within the tank, and the platform is submerged in the liquid resin and moved downwards to the lowest position, at a specific distance between its bottom surface and the top surface of the transparent window. The zone—so-called “polymerization zone”—formed between both surfaces is filled with liquid resin. Upon exposure to light, the first solidified layer is formed in the polymerization zone and adheres to the bottom surface of the platform, while preferably not adhering to the top surface of the transparent window. Absent from any light, the build platform incrementally moves upwards, to create a new polymerization zone between the bottom surface of the solidified layer and the top surface of the transparent window, in which some liquid resin flows, for forming an additional layer of polymerized resin upon subsequent light exposure. The incremental move of the platform and the light exposure is repeated as often as necessary to obtain the solid three-dimensional article. If necessary, the platform may be moved incrementally further than the distance needed for forming a layer of polymerized resin, for ensuring that a sufficient and homogenous volume of resin flows to the polymerization zone, before being moved downwards again to the distance, which is suitable for forming a layer of polymerized resin.

The “slice-at-a-time” serial processing method allows obtaining satisfactory three-dimensional articles. However, this method is laborious and time-consuming, and has also several additional drawbacks. For example, cured layer stratification may be visible under powerful magnification, or even to the naked eye. The 3D article may exhibit some anisotropy in mechanical properties. The aesthetics may be compromised, particularly for the surfaces angled in the vertical Z axis. The 3D article may also have defects, particularly caused by the up and down movements of the platform.

Alternative methods, based on the principle of continuous 3D printing, have been developed, particularly for tackling the drawbacks associated with the up and down movements of the platform. Such methods may be continuous linear methods (continuous extraction methods) or continuous volumetric methods.

PCT application WO 2014/126834 A1 published on 21 Aug. 2014 and the article entitled “Continuous liquid interface production of 3D objects” by from J. R. Tumbleston et al., Sciencexpress (2015) describe the method called “continuous liquid interface printing (CLIP)”. In the CLIP method, the need for the repeated up and down movements of the platform is avoided and formed parts are “extracted” in a continuous way. The CLIP method is based on the continuous presence of unpolymerized liquid resin in the zone formed between the bottom surface of the platform/article and the top surface of the transparent window. This is achieved by balancing the inhibition and the initiation of the photopolymerization in this zone, via a decreasing gradient of an inhibitor of polymerization from the top surface of the transparent window to the bottom surface of the platform/article. This zone is therefore divided into two different zones that merge i.e. the polymerization zone per se and a so-called “dead zone” located in the vicinity of the top surface of the transparent window, wherein the inhibitor is present at a sufficient concentration for inhibiting the photopolymerization. At a threshold distance from the top surface of the transparent window, roughly demarcating the dead zone from the polymerization zone, the photopolymerization is no longer inhibited. The 3D article can be printed continuously, instead of step-by-step. PCT application WO 2014/126834 A1 describes alternative inhibition/photopolymerization systems i.e. one system wherein the liquid resin comprises a free radical polymerizable liquid resin with normal free radical stabilizers present for shelf-life and an additional inhibitor comprises oxygen (e.g. air, gas enriched in oxygen or pure oxygen gas), and another system wherein the liquid resin comprises an acid-catalyzed or cationically-polymerizable liquid resin and the inhibitor comprises a base (e.g. ammonia, trace amines or carbon dioxide). Additional inhibitor(s) may be provided to the bath of liquid resin through a window made of a material permeable to the inhibitors of polymerization, e.g. semipermeable fluoropolymers, rigid gas-permeable polymers, porous glass, or combinations thereof. J. R. Tumbleston et al. describes a method, wherein oxygen diffuses through the window and into the resin, but decays with distance from the window, so that photoinitiation overpowers oxygen-inhibition at some distance from the window. Hence, at the threshold distance, where inhibition including that by oxygen is consumed and initiating free radicals still exist, polymerization begins. This method allows the much faster manufacturing 3D articles showing no layer stratification and anisotropy in parts.

PCT application WO 2015/164234 A1 published on 29 Oct. 2015 also describes an alternative CLIP method, wherein the tank is filed with two layers of liquids. The top layer comprises the liquid resin, and a bottom layer comprises an immiscible liquid, which is immiscible, but wettable with the resin and has a density greater than the resin. Inhibitors of polymerization e.g. oxygen, bases or organic compounds may also be used.

PCT application WO 2016/172784 A1 published on 3 Nov. 2016 describes the method called “Intelligent Liquid Interface (ILI)”. The ILI method does not rely on the provision of inhibitors of polymerization. Instead, the top surface of the optically transparent bottom wall of the tank is coated with a wettable material e.g. a silicone hydrogel. A dead zone is formed atop the wettable material, as a result of the intermolecular forces of repulsion between the wettable material and the resin, or as a result of the formation of a layer of water (present in the wettable material), in which the resin is immiscible. The US application 2018/0207867 A1 published on 26 Jul. 2018 describes a method, wherein the optically transparent portion is covered by a layer gradually releasing a liquid lubricant. The US application 2017/0129175 A1 published on 11 May 2017 describes an ILI method, wherein the wettable membranes are movable and not static.

PCT application WO 2018/208378 published on 15 Nov. 2018, the article entitled “Volumetric 3D printing of elastomers by tomographic back-projection” by D. Loterie (2018) and the article entitled “Volumetric additive manufacturing via tomographic reconstruction” by B. E. Kelly et al., Science (2019) describe the method called “Computed Axial Lithography (CAL)”, based on a volumetric continuous printing. In the CAL method, a standard resin is contained within a rotatable, optically transparent tank. It may comprise free radical polymerizable liquid resin and radical stabilizers including oxygen, which act as inhibitors of photopolymerization. Any and all stabilizers are already present in the resin and are not continuously supplied. Light projections from the side of the tank are simultaneously directed at a plurality of angles. The superposition of exposures from different angles results in a 3D energy dose which is sufficient to photopolymerize the resin in the desired geometry.

The article entitled “Two-color single-photon photoinitiation and photoinhibition for subdiffraction photolithography” by T. F. Scott et al., Science (2009), US application 2012/0092632 A1 published on 19 Apr. 2012 and the article entitled “Rapid, continuous additive manufacturing by volumetric polymerization inhibition patterning” by M. P. de Beer et al., Science Advances (2019) describe a dual-wavelength volumetric photopolymerization method. In this method, one wavelength is used to photochemically activate the polymerization, while a second wavelength is used to inhibit that reaction. M. P. de Beer et al. also discloses hexaarylbiimidazoles as radical polymerization photoinhibitors, even though the concept of “photoinhibition” is relatively rare.

Continuous 3D printing methods are advantageous over methods based on the layer-by-layer approach, particularly due to their speed of article formation and the quality of the printed parts. Many of these methods rely on the use of inhibitors of photopolymerization, particularly inhibitors for free radical polymerizable liquid resin, such as oxygen or air. Indeed, irrespective of the types of polymerizable liquid resins used for example in CLIP methods—including polyurethane, epoxy, cyanate ester, and silicone resins—all depend on oxygen inhibited acrylic cures. No alternative resin systems have been demonstrated. However, the use of such liquid resins is associated with several drawbacks. Firstly, the need to finely tune the sensitivity of these liquid resins to radical photopolymerization in the action of continuous printing, in turn creates stability issues with product storage and usually requires packaging and selling these as two-part formulations that are mixed before use. Secondly, these liquid resins should be further finely tuned to function when balancing inhibition by controlling the diffusion of supplied oxygen. Thirdly, the oxygen diffusion varies as a function of the resin viscosity, and therefore needs to be adjusted depending on resin type and its pot life. Fourthly, costly specialized membranes with high permeability to air/oxygen and transparency are required to form the optically transparent portion.

Different liquid resins are conventionally used in 3D printing methods. For example, in theory, the liquid resins may comprise polymerizable monomers selected from the group consisting of acrylics, methacrylics, acrylamides, styrenics, olefins, halogenated olefins, cyclic alkenes, maleic anhydride, alkenes, alkynes, carbon monoxide, functionalized oligomers, multifunctional cure site monomers, functionalized PEGs, and combinations thereof. See for example WO 2015/164234 A1, WO 2015/164234 A1, and the article by D. Loterie (2018). However, in practice, the vast majority of photopolymerized 3D articles are obtained from free radical polymerizable monomers, particularly from (meth)acrylates and their derivatives, which are commonly inhibited by oxygen or air, as disclosed in the article entitled “Role of Oxygen in polymerization reactions” by V. A. Bhanu et al., Chemical Reviews (vol. 91, No. 2, 1991). Controlling inhibition by oxygen or air can be used advantageously to create polymerization dead zones during 3D printing, for example in conventional CLIP method. However, oxygen inhibition also is disadvantageous in that printing with (meth)acrylated resins provides articles whose surfaces are in contact with ambient air (oxygen) and thus remain partially uncured and tacky. In order to obtain a tack-free surface, the 3D printed article should thus be post-processed (see e.g. in WO 2019/043529 A1). The post-processing to complete cure of the 3D printed articles may require additional hardware and currently is a time-consuming process that may also involve heating.

There is thus a need for optimizing the benefits of all 3D printing methods, particularly continuous 3D printing methods, being independent from inhibition by oxygen or air. There is also the need for providing a 3D printing method enabling the printing of 3D articles having no surface-tackiness, whether used in the continuous extraction approach e.g. the CLIP method, or in the volumetric approach or in layer-by-layer approach. There is also the need for providing a 3D printing method, wherein the post-processing step, if needed, is simplified. There is also the need to supply shelf-stable one-part liquid resin systems with long lifetime storage. There is also the need for providing a 3D printing method that can exploit relatively simple equipment without the need for special hardware e.g. to provide or transport gases.

### SUMMARY OF THE INVENTION

It is a first object of the invention to provide a method for printing a three-dimensional (3D) article, comprising the steps of:

a) providing a volume of liquid resin comprising cyanoacrylate-based monomers, a photoinitiator system and an acidic inhibitor, held in a tank, said tank comprising at least one optically transparent portion;

b) defining a polymerization zone;

c) emitting and controlling light and transmitting it to the liquid resin through the optically transparent portion for selectively polymerizing the liquid resin in the polymerization zone; and

d) obtaining a three-dimensional article made of a polymerized resin.

In some embodiments, the method is a layer-by-layer 3D printing method or a continuous 3D printing method; preferably a continuous 3D printing method being a continuous linear (extraction) 3D printing method or a continuous volumetric 3D printing method; more preferably the method is selected from the group consisting of the continuous liquid interface printing method (CLIP method), the intelligent liquid interface method (ILI method), the computed axial lithography method (CAL method), the dual-wavelength volumetric photopolymerization method, and the methods derived therefrom.

In some embodiments, the cyanoacrylate-based monomers are selected from the group consisting of mono-functional cyanoacrylate monomers, multi-functional cyanoacrylate monomers including bifunctional cyanoacrylate monomers, hydrid cyanoacrylate monomers, and mixtures thereof.

In some embodiments, the acidic inhibitor present in the liquid resin is selected from Lewis acids, Bronsted acids or mixtures thereof; preferably from Lewis acids; more preferably from the group consisting of boron trifluoride and derivatives, fluoroboric acid, sulphur dioxide, and mixtures thereof; still more preferably from the group consisting of boron trifluoride, boron trifluoride etherate complex, boron trifluoride dihydrate complex, boron trifluoride tetrahydrofuran complex, trimethylsilyl triflate, sulphur dioxide, and mixtures thereof; most preferably the Lewis acid is etherate complex.

In some embodiments, the method further comprises the step of providing an additional source of acidic inhibitors; preferably an additional source of acidic inhibitors selected from the group consisting of Lewis acids, Bronsted acids, acids provided from an acidic ion exchange material or in situ photogenerated acids.

In some embodiments, the additional acidic inhibitors diffuse to the volume of liquid resin from/through the optically transparent portion.

In some embodiments, the additional acidic inhibitors diffuse to the volume of liquid resin from a separate compartment.

In some embodiments, the additional acidic inhibitors are in contact with the volume of liquid resin from a liquid or wettable, optically transparent material overlying the inner surface of the optically transparent portion of the tank.

In some embodiments, it is provided a resin-immiscible liquid, also held in the tank, wherein the additional acidic inhibitors are in contact with the liquid resin at the interface with the resin-immiscible liquid.

In some embodiments, an additional light, of a different wavelength than the light selectively polymerizing the liquid resin, is emitted and transmitted to the liquid resin, and additional acidic inhibitors are generated in the volume of liquid resin by additional light. The additional acidic inhibitors are thus latent until photogenerated in situ in the volume of liquid resin.

In some embodiments, the liquid resin comprises, as the photoinitiator system, a combination of metallocene compounds and radical photoinitiators.

In some embodiments, the liquid resin comprises additional photopolymerizable monomers, preferably (meth)acrylate monomers.

It is a second object of the invention to provide a three-dimensional printing system comprising:

a) a volume of liquid resin comprising cyanoacrylate-based monomers, a photoinitiator system and an acidic inhibitor, said volume comprising a polymerization zone;

b) a tank for holding the volume of liquid resin, said tank comprising at least one optically transparent portion; and

c) a light source emitting light for selectively polymerizing the liquid resin in the polymerization zone.

It is a third object of the invention to provide the use of a liquid resin comprising cyanoacrylate-based monomers, a photoinitiator system and an acidic inhibitor in a system for printing three-dimensional articles.

It is a fourth object of the invention to provide a three-dimensional printed article obtained by the method according to any one of claims.

It is a fifth object of the invention to provide a three-dimensional printed article made of polycyanoacrylate, preferably an unstratified, tack-free three-dimensional printed article made of polycyanoacrylate.

The present invention makes it possible to overcome the drawbacks of the prior art. The invention provides a 3D printing method, particularly a continuous 3D printing method, being independent from inhibition by oxygen or air, and not relying on radical photopolymerization as the principle method of initiation, contrary to conventional liquid resins. The invention also provides a 3D printing method using a liquid resin being easily stored and being stable over time, i.e. not needing any specific packing conditions such as multicompartment formulations and/or having a limited shelf-life due to instability. The invention also provides a 3D printing method enabling the printing of 3D articles that do not exhibit stratification. The invention also provides a 3D printing method enabling the printing of 3D articles having no surface-tackiness whether used in continuous linear approach or in volumetric approach or layer-by-layer approach. The invention also provides a 3D printing method that can exploit relatively simple equipment without the need for special hardware e.g. to provide or transport gases or complex peripheral hardware to post-process 3D printed articles having tacky surfaces due to air inhibition. The invention also provides a 3D printing method enabling obtaining 3D articles of improved quality, while relying on conventional physical and optical settings.

The inventors have shown that liquid resins comprising cyanoacrylate-based monomers are uniquely adaptable to 3D printing methods, in a variety of modes with very simple and low-cost equipment and that the physical properties of the printed 3D objects can be readily modified. Indeed, 3D printed articles of improved quality, particularly not exhibiting layer stratification and/or not having surface-tackiness, can be obtained with conventional 3D printing systems using liquid resins comprising cyanoacrylate-based monomers, without requiring any specific adaptation of their physical and optical settings.

### DESCRIPTION OF THE FIGURES

FIGS. 1A and 2A are photographs under electron microscopy of 3D articles according to example 1

FIGS. 1B and 2B are photographs under optical contour mapping of 3D articles according to example 1

FIG. 3 is a schematic representation of the tank according to example 2

FIG. 4 is a schematic representation of the system according to example 3

FIG. 5 is a schematic representation of the tank according to example 4

FIG. 6 is a schematic representation of the system according to example 5

FIG. 7 is a photograph of a 3D article printed according to example 6

FIG. 8 is a graph showing the heat output due to the exotherm of the initiated polymerization (Y axis) as a function of time (Z axis), according to example 8

FIG. 9 is a graph showing the heat output due to the exotherm of the initiated polymerization (Y axis) as a function of time (Z axis), according to example 11

FIG. 10 is a photograph of a boat-shaped 3D printed article according to example 10

### DESCRIPTION OF EMBODIMENTS

The invention will now be described in more detail without limitation in the following description.

Throughout the description, all the percentages of the various constituents of the composition are given by weight (% w/w), except if mentioned otherwise. The concentration ranges have to be considered as including the limits.

The expressions “printing method (method for printing)” and “manufacturing method (method for manufacturing)” are used interchangeably presently. Likewise, the expressions “printing system” and “manufacturing system” are used interchangeably presently.

The present invention relates to a method for printing a three-dimensional article and the corresponding three-dimensional printing system and use thereof, as well as related 3D articles.

3D Printing Method

The present invention can be applied to any suitable conventional 3D printing methods using a photopolymerizable liquid resin, particularly without requiring any specific adaptation of their physical and optical settings.

The inventors have demonstrated the great versatility of using a liquid resin comprising cyanoacrylate-based monomers, photoinitiators and acidic inhibitors. Indeed, a liquid resin comprising cyanoacrylate-based monomers can be used in conventional 3D printing systems with or without simple modifications. In addition, the acidic inhibitors can be supplied in any form and manner. The suitable acidic inhibitors, and their supplies, may therefore be selected depending on the 3D printing method used. Particularly, the acidic inhibitors may be present originally in the liquid resin i.e. as the sole or a primary source of acidic inhibitors. In addition, a secondary source of acidic inhibitors may also be provided.

The 3D printing method may be a layer-by-layer 3D printing method. Alternatively and preferably, the 3D printing method may be a continuous 3D printing method, particularly a continuous linear 3D printing method or a continuous volumetric 3D printing method. Without wishing to be exhaustive, the continuous 3D printing method may be selected from the group consisting of the continuous liquid interface printing method (CLIP method), the intelligent liquid interface method (ILI method), the computed axial lithography method (CAL method), the dual-wavelength volumetric photopolymerization method, and the methods derived therefrom. The CAL method and the dual-wavelength volumetric photopolymerization method are referred presently as “volumetric printing methods”. These methods and their suitable physical and optical settings are known in the art.

The 3D printing method may be implemented by the printing system described herein. The 3D printing method allows the printing of 3D articles made of polycyanoacrylate.

Printing System

Existing printing methods can be used with the present invention without limitation particularly, since acid inhibitors stabilize cyanoacrylate-based monomers effectively outside the polymerization zone, while light is transmitted to the liquid resin to selectively polymerize such resins within the polymerization zone. Indeed, the acidic inhibitor(s) generally keeps(−) concurrently preventing the polymerization of the cyanoacrylate-based monomers outside the polymerization zone, when light is transmitted to the liquid resin for selectively polymerizing it.

Tank

A tank is provided. The tank comprises at least one compartment for holding the liquid resin. The tank usually comprises a bottom wall and at least one side wall. The tank may open or closed at its top. The tank may have any suitable shape, cross-section and dimensions. For example, the bottom wall may have a cross-section being circular, square or rectangular. If the cross-section of the bottom wall is circular, the tank may have one circumferential cylindrical side wall. If the cross-section of the bottom wall is square or rectangular, the tank may have four side walls. In continuous linear 3D printing methods such as in CLIP and ILI methods, the tank preferably has a square or rectangular cross-section. In volumetric 3D printing methods, the tank preferably has a circular cross-section and forms a cylinder.

The tank may be fixed or rotatably moveable. In continuous linear 3D printing methods such as in CLIP and ILI methods, the tank is preferably fixed. In volumetric 3D printing methods, the tank is preferably rotatably moveable around a vertical Z axis.

Optically Transparent Portion

The tank comprises at least one optically transparent portion. The optically transparent portion may be located on the bottom wall, on the side walls, or both. In continuous linear 3D printing methods such as in CLIP and ILI methods, the optically transparent portion is preferably located on the bottom wall of the tank, and may be planar. In volumetric 3D printing methods, the optically transparent portion is preferably located on the side wall of the tank.

The inner surface of the optically transparent portion, in contact with the liquid resin, may be treated for preventing adhesion of the polymerized resin on it. For example, a fluorinated coating in the form of a transparent impermeable plastic sheet may be applied. Alternatively, as described in the US application 2017/0028618 A1, high-density, immiscible perfluorinated liquids may be disposed atop the inner surface of the optically transparent portion. Perfluorinated liquids may be perflourinated sulfonic acids (also known as perfluorinated octanesulfonic acid or PFOS).

The material forming the optically transparent portion may be selected depending on the properties expected. For example, the optically transparent portion may be made in a material being permeable to the acidic inhibitors.

Partition Wall

The tank may comprise a partition wall, for dividing the tank into two compartments i.e. a top compartment and a bottom compartment. The top compartment may hold the liquid resin, while the bottom compartment may hold another liquid e.g. an additional source of acidic inhibitors such as a solution of acidic inhibitor.

The partition wall may be nonpermeable to the liquid resin, but permeable to acidic inhibitors. The partition wall may also comprise at least one optically transparent portion.

Liquid or Wettable, Optically Transparent Material

The tank may comprise a liquid or wettable, optically transparent material, such as a membrane overlying the inner surface of the optically transparent portion of the tank.

This material may comprise acidic inhibitors derived from acids or acid groups. It may alternatively be continuously fed by a source of acid.

Light Source

A light source is provided. The light source emits light from one or a plurality of elements.

The light source is located outside the tank, in a position suitable for allowing the transmission of the light to the volume of liquid resin, particularly the photopolymerization zone, through the optically transparent portion.

The light may be continuously emitted and transmitted, for continuously photopolymerizing the liquid resin.

In continuous 3D printing methods such as in CLIP, ILI and volumetric printing methods, the light is usually emitted and transmitted continuously. In the course of the printing, the light may be controlled for customizing the shape of the 3D article.

In continuous linear 3D printing methods such as CLIP and ILI methods, the light source is located below the tank, and the light is emitted and transmitted through the optically transparent portion located in the bottom wall of the tank. If the tank comprises a bottom compartment and a top compartment, the light is also emitted and transmitted through the optically transparent partition wall.

In the volumetric 3D printing methods, the light source(s) may be located, to one side of the tank.

The light source emits light for polymerizing the liquid resin (polymerization light). The polymerization light may have a wavelength from 360 nm to 465 nm, preferably from 385 nm to 420 nm, more preferably from 405 nm to 415 nm.

In some special case printing methods, the light source may emit additional light for photoinhibiting the polymerization (inhibiting light). The additional light has different wavelength than the light for polymerizing the liquid. The photoinhibition light may have a wavelength from 300 nm to 500 nm, preferably from 350 nm to 450 nm, more preferably from 360 nm to 410 nm. The wavelength of the polymerization light and the wavelength of the additional light, which are different from each other, depend on the liquid resin and the type of polymerizable monomers. In these printing methods, even though photoinitiating and photoinhibiting wavelength ranges may be similar, it is understood that the selected wavelengths for initiating and inhibiting must not interfere or be the same.

Light-Controlling Device

A light-controlling device is usually provided. This device may be part of the light source or independent to it. For example, the light-controlling device may be a digital light projector, a LCD mask, a shutter or a scanned laser.

When independent from the light source such as the mask or the shutter, the light-controlling device is interposed between the light source and the external surface of the optically transparent portion. The mask and the shutter may be useful for giving a specific pattern and/or intensity to the light, in order to photopolymerize the resin in a specific shape. Alternatively, the light pattern may be created directly by the so-called stereolithographic approach (SLA).

The use of a light-controlling device helps obtaining 3D articles having more or less complex shapes.

Platform

Depending on the printing method, a platform may be provided. When a platform is present, it is usually moveably mounted on an arm, for allowing moving the platform up and down.

Usually, continuous 3D printing methods such as CLIP and ILI methods comprise a platform, particularly a planar platform, which is submerged in the liquid resin. The first layer of photopolymerized resin is formed on and adheres to the bottom surface of the platform, which is facing the top surface of the optically transparent portion.

Volumetric printing methods generally do not utilize a platform but print 3D articles in the volume of the liquid resin that are self-supporting or may be printed atop or around an inserted substrate.

Liquid Resin

A volume of a liquid resin is provided. The volume of liquid resin is held in the tank.

The liquid resin is held in the compartment formed by tank. If a partition wall is present, the liquid resin is held in the top compartment of the tank.

The liquid resin comprises cyanoacrylate-based monomers.

The volume of the liquid resin comprises a polymerization zone. By “polymerization zone” is meant a specific zone of the volume of the liquid resin, where the polymerization happens when the necessary conditions of exposure to induce photopolymerization are met. The polymerization zone may vary depending on the printing method used. For example, in the CLIP method, the polymerization zone is particularly demarcated by the bottom surface of the platform/article and the top surface of the optically transparent portion of the tank. In the CAL method, the polymerization zone is demarcated by the pattern formed by the light. The polymerization zone thus depends on the conventional physical and optical settings of the 3D systems.

The volume of the liquid resin may also comprise a dead zone. By “dead zone” is meant a specific zone in the vicinity of the polymerization zone, where the polymerization does not happen, even when the necessary conditions of exposure to induce photopolymerization are met. The dead zone is particularly present in continuous linear methods e.g. in the CLIP method. The dead zone is located in the vicinity of the bottom of the compartment holding the liquid resin (i.e. the top surface of the transparent window, the partition wall, the liquid or wettable material or any other means). In this embodiment, the dead zone is sandwiched between the bottom of the compartment holding the liquid resin and the polymerization zone. The dead zone may be obtained by the presence of acidic inhibitors including the secondary source of acidic inhibitors at a sufficient concentration for inhibiting the photopolymerization. Hence, the concentration of acidic inhibitors decreases with distance above the bottom of the compartment holding the liquid resin, so that a threshold is reached whereby photoinitiation purposely overpowers the acidic inhibition at some distance between the dead zone and the polymerization zone.

The liquid resin has a suitable viscosity. Particularly, the liquid resin may have a viscosity from 2 mPa·s to 100,000 mPa·s. In continuous 3D printing methods such as such as CLIP and ILI methods, the liquid resin may have a viscosity from 10 mPa·s to less than 10,000 mPa·s, preferably from 10 mPa·s to 2,000 mPa·s; or alternatively gel-like viscosities may also be deployed with viscosities from 10,000 cPs to 100,000 cPs. In volumetric 3D printing methods, the liquid resin preferably has a viscosity from 100 cPs to 100,000 cPs. Viscosity is measured using a Brookfield DV2T Viscometer with a thermostatic chamber equilibrated at 25° C. The spindles and shear rate are chosen to suit viscosity ranges, thus 1.5 r.p.m using spindle 14 for high viscosity range and 50 r.p.m. using spindle 21 for low viscosity range.

The liquid resin may be at a temperature from 20° C. to 70° C.

In some embodiment, the liquid resin is at room temperature. By “room temperature” is meant a temperature from 18° C. and 25° C.

In some embodiments, the liquid resin is at temperature higher than the liquid resin, such as a temperature from 35° C. to 75° C. In such case, a heating device is provided.

Cyanoacrylate-Based Monomers

The liquid resin comprises cyanoacrylate-based monomers, which are photopolymerizable monomers. Cyanoacrylate (CA) is the generic name given to a family of alpha-nitrile substituted acrylic esters that are rapidly polymerisable. The terms “cyanoacrylate(s)”, “cyanoacrylate monomers” and “cyanoacrylate-based monomer(s)” are used interchangeably presently.

Cyanoacrylate-based monomers are particularly suitable for an anionic or a zwitterionic polymerization. The mechanism of anionic polymerization is described in the article by Pepper et al., J. Polym. Sci: Polymer Symposium 62, 65-77 (1978) and the article entitled “Zwitterionic polymerization of butyl cyanoacrylate by triphenylphosphine and pyridine” by Cronin et al., Makromol. Chem., 189, 85, (1988). To be specific, the mechanism of the photopolymerization of cyanoacrylate monomers is initiated by electron-rich species that have been photogenerated.

The inventors have surprisingly demonstrated that satisfactory printing methods may be developed, using liquid resins different from conventional liquid resins i.e. liquid resins comprising (meth)acrylate monomers or other similar monomers. Indeed, the photopolymerization of (meth)acrylate monomers is based on free radical polymerization. However, free radical polymerization is inhibited by oxygen (air). Even though the oxygen inhibition of free radical photopolymerization has been used in some printing methods such the CLIP method, it has drawbacks. Particularly, the printed 3D articles usually show surface-tackiness, therefore requiring post-processing to render them dry-to-touch. In contrast, by using cyanoacrylate-based monomers, the inventors have demonstrated that 3D articles being tack-free, or having at least a limited surface-tackiness, could be printed, without impairing the efficacy of the photopolymerization. The inventors have also demonstrated no layering (stratification) phenomena occurs, when using liquid resin comprising cyanoacrylate-based monomers, especially in 3D printing methods based on the layer-by-layer approach. Additionally, liquid resins comprising cyanoacrylate-based monomers are stable upon time, particularly since they comprise acidic inhibitors, and do not require any special storage conditions, except shielding from light as with photocurable resins of any type.

Cyanoacrylate-based monomers may be mono-functional cyanoacrylate monomers, multi-functional cyanoacrylate monomers including bifunctional cyanoacrylate monomers, hydrid cyanoacrylate monomers, and mixtures thereof. Hybrid cyanoacrylate monomers are cyanoacrylate-based monomers comprising at least one additional moiety other than a cyanoacrylate moiety, preferably with the capacity to polymerize or react from the additional moiety e.g. monomers comprising a cyanoacrylate moiety and a (meth)acrylate moiety, or monomers comprising a cyanoacrylate moiety and a isocyanate moiety. Using multi-functional cyanoacrylate monomers and/or hydrid cyanoacrylate monomers, in addition to or instead of mono-functional cyanoacrylate monomers, may help obtaining polymers with improved properties through secondary reactions such as crosslinking, condensations and/or copolymerization that contribute to durability, toughness, flexibility, etc.

Monofunctional cyanoacrylate monomers have the chemical formula (I):

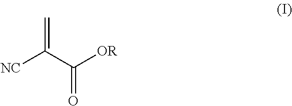

wherein R may be selected from the group consisting of an alkyl group or an alkoxyalkyl group. The alkyl group may be selected from the group consisting of methyl, ethyl, butyl, or 2-octyl. The alkoxyalkyl group may be selected from the group consisting of 2-methoxyethyl, 2-ethoxyethyl, or 2-(1-methoxy)propyl.

An exemplary monofunctional cyanoacrylate monomer is ethyl cyanoacrylate (ECA), wherein R=C₂H₅. While being suitable for use in the present invention, ECA is least preferred in view of its volatility, its odor and its staining potential. In some embodiments, the liquid resin is free of ethyl cyanoacrylate.

Other exemplary monofunctional cyanoacrylate monomers are 2-methoxyethyl cyanoacrylate (MECA), wherein R═CH₂CH₂OCH₃; 2-ethoxyethyl cyanoacrylate (EECA), wherein R═CH₂CH₂OC₂H₅; and 2-(1-methoxy)propyl cyanoacrylate (MPCA), wherein R═CH(CH₃)CH₂OCH₃. MECA is particularly suitable for use in the present invention, considering its odorless, non-lachrymatory, non-irritant and non-staining properties. A high-yield process for preparing MECA and related cyanoacrylates is disclosed in the US application 9,670,145 published on 26 Jan. 2017.

Monofunctional cyanoacrylate monomers are well known in the art. See for example the review entitled “Adhesives Technology Handbook” by from S. Ebnesajjad Ed., William Andrew, Norwich (2008).

Multifunctional cyanoacrylate monomers, including bifunctional cyanoacrylate monomers, are disclosed in the article entitled “Unequivocal Synthesis of Bis(2-cyanoacrylate) Monomers. Via Anthracene Adduct” by C. Buck, J. Polymer Sci, Polym. Chem Edition, Vol 16, 2475, (1978).

Bifunctional cyanoacrylate monomers may have the chemical formula (II):

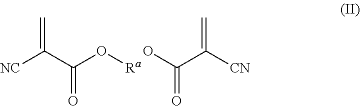

wherein R^{a} is selected from the group consisting of —(CH₂)ₙ with n=2 to 12, —CH₂(C(CH₃)₂CH₂)—, —CH(CH₃)CH₂CH₂CH(CH₃)—, —CH₂C₆H₄CH₂— including 1,3- or 1,4-disubstituted aromatic), —(CH₂)₄O(CH₂)₄—, —CH₂(CF₂)₃CH₂—, —CH₂Si(CH₃)₂OSi(CH₃)₂CH₂—, —CH₂CH═CHCH₂— or —CH₂C≡CCH₂—.

Hybrid cyanoacrylate monomers may have the chemical formula (III):

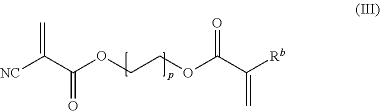

wherein R^{b} is —H or —CH₃; and wherein p is 1.

Hydrid cyanoacrylate monomers may have the chemical formula (IV):

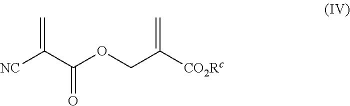

wherein R^{c} is —CH₃ or —C₂H₅.

The cyanoacrylate-based monomers may be selected depending on the 3D article to be printed, considering their specific properties including their solubility or insolubility, their toughness, their flexibility, their rigidness, their resistance, etc.

As defined herein before, the cyanoacrylate-based monomer may be selected from the group consisting of monomers of structure (I), monomers of structure (II), monomers of structure (III), monomers of structure (IV), and mixtures thereof.

The cyanoacrylate-based monomers may be low-odor or odorless monomers such as alkoxyalkyl cyanoacrylate esters.

The cyanoacrylate-based monomers may be low-staining or non-staining monomers.

The cyanoacrylate-based monomers may be selected from the group consisting of 2-methoxyethyl cyanoacrylate, 2-ethoxyethyl cyanoacrylate, 2-(1-alkoxy)propyl cyanoacrylate, 2-(2′-alkoxy)-methoxyethyl-2″-cyanoacrylate, 2-(2′-alkoxy)-ethoxyethyl-2″-cyanoacrylate, 2-(2′-alkoxy)-propyloxypropyl-2″-cyanoacrylate, 2-(2′-alkoxy)-butyloxybutyl-2″-cyanoacrylate, 2-(3′-alkoxy)-propyloxyethyl-2″-cyanoacrylate, 2-(3′-alkoxy)-butyloxyethyl-2″-cyanoacrylate, 2-(3′-alkoxy)-propyloxypropyl-2″-cyanoacrylate, 2-(3′-alkoxy)-butyloxypropyl-2″-cyanoacrylate, 2-(2′-alkoxy)-ethoxypropyl-2″-cyanoacrylate, 2-(2′-alkoxy)-ethoxybutyl-2″-cyanoacrylate, n-butyl cyanoacrylate, sec-butyl cyanoacrylate, iso-butyl cyanoacrylate, n-pentyl cyanoacrylate, 1-methylbutyl cyanoacrylate, 1-ethylpropyl cyanoacrylate, n-hexyl cyanoacrylate, 1-methylpentyl cyanoacrylate, n-heptyl cyanoacrylate, n-octyl cyanoacrylate, 2-octyl cyanoacrylate, 2-ethylhexyl cyanoacrylate, n-nonyl cyanoacrylate, n-decyl cyanoacrylate, n-undecyl cyanoacrylate, n-dodecyl cyanoacrylate, cyclohexyl cyanoacrylate, n-octadecyl cyanoacrylate, trimethylsilyethyl cyanoacrylate, trimethylsilypropyl cyanoacrylatetrimethylsilyloxyethyl cyanoacrylate triethylsilyloxyethyl cyanoacrylate phenylethyl cyanoacrylate, phenoxyethyl cyanoacrylate, and mixtures thereof; preferably from the group consisting of 2-(2′-alkoxy)-methoxyethyl-2″-cyanoacrylate, 2-(2′-alkoxy)-ethoxyethyl-2″-cyanoacrylate, and mixtures thereof; more preferably the group consisting of 2-(2′-alkoxy)-methoxyethyl-2″-cyanoacrylate.

If present, the alkoxy group is selected from the group consisting of methoxy, ethoxy, propyloxy, butyloxy, pentyloxy or hexyloxy.

A suitable 2-(1-alkoxy)propyl cyanoacrylate may be 2-(1-methoxy)propyl cyanoacrylate. A suitable 2-(2′-alkoxy)-methoxyethyl-2″-cyanoacrylate may be 2-(2′-methoxy)-methoxyethyl-2″-cyanoacrylate. Suitable 2-(2′-alkoxy)-ethoxyethyl-2″-cyanoacrylates may be 2-(2′-methoxy)-ethoxyethyl-2″-cyanoacrylate, 2-(2′-ethoxy)-ethoxyethyl-2″-cyanoacrylate, 2-(2′-propyloxy)-ethoxyethyl-2″-cyanoacrylate, 2-(2′-butoxy)-ethoxyethyl-2″-cyanoacrylate, 2-(2′-pentyloxy)-ethoxyethyl-2″-cyanoacrylate, 2-(2′-hexyloxy)-ethoxyethyl-2″-cyanoacrylate. Suitable 2-(2′-alkoxy)-propyloxypropyl-2″-cyanoacrylates may be 2-(2′-methoxy)-propyloxypropyl-2″-cyanoacrylate, 2-(2′-ethoxy)-propyloxypropyl-2″-cyanoacrylate, 2-(2′-propyloxy)-propyloxypropyl-2″-cyanoacrylate, 2-(2′-butyloxy)-propyloxypropyl-2″-cyanoacrylate, 2-(2′-pentyloxy)-propyloxypropyl-2″-cyanoacrylate, 2-(2′-hexyloxy)-propyloxypropyl-2″-cyanoacrylate. Suitable 2-(2′-alkoxy)-butyloxybutyl-2″-cyanoacrylates may be 2-(2′-methoxy)-butyloxybutyl-2″-cyanoacrylate, 2-(2′-ethoxy)-butyloxybutyl-2″-cyanoacrylate, 2-(2′-butyloxy)-butyloxybutyl-2″-cyanoacrylate. A suitable 2-(3′-alkoxy)-propyloxyethyl-2″-cyanoacrylate may be 2-(3′-methoxy)-propyloxyethyl-2″-cyanoacrylate. A suitable 2-(3′-alkoxy)-butyloxyethyl-2″-cyanoacrylate may be 2-(3′-methoxy)-butyloxyethyl-2″-cyanoacrylate. A suitable 2-(3′-alkoxy)-propyloxypropyl-2″-cyanoacrylate may be 2-(3′-methoxy)-propyloxypropyl-2″-cyanoacrylate. A suitable 2-(3′-methoxy)-butyloxypropyl-2″-cyanoacrylate may be 2-(3′-alkoxy)-butyloxypropyl-2″-cyanoacrylate. A suitable 2-(2′-alkoxy)-ethoxypropyl-2″-cyanoacrylate may be 2-(2′-methoxy)-ethoxypropyl-2″-cyanoacrylate. A suitable 2-(2′-alkoxy)-ethoxybutyl-2″-cyanoacrylate may be 2-(2′-methoxy)-ethoxybutyl-2″-cyanoacrylate.

An exemplary cyanoacrylate monomer is 2-methoxyethyl cyanoacrylate.

Suitable processes for preparing cyanoacrylate-based monomers are particularly disclosed in the U.S. Pat. No. 2,467,927 and in the U.S. Pat. No. 9,670,145.

The liquid resin may comprise from 45 to 100% by weight, preferably from 70 to 98% by weight, more preferably from 90 to 98% by weight, of cyanoacrylate-based monomers, by total weight of the liquid resin.

The liquid resin may comprise from 1 to 25% by weight, preferably from 3 to 15% by weight, more preferably from 5 to 10% by weight, of multifunctional cyanoacrylate monomers and/or hydrid cyanoacrylate monomers, by total weight of the polymerizable monomers.

Additional Photopolymerizable Monomers

In addition to cyanoacrylate monomers, the liquid resin may also comprise additional photopolymerizable monomers, preferably (meth)acrylate monomers. US application 2018/215973 describes suitable (meth)acrylate monomers.

The (meth)acrylate monomers may be selected from the group consisting of monofunctional (meth)acrylate monomers, polyfunctional acrylate monomers, and mixtures thereof. The monofunctional (meth)acrylate monomers may be selected from linear or branched alkyl, alkoxylakyl, furfuryl, isobornyl, glycidyl, or phenoxyethyl, esters and the cyclic and heterocyclic esters. Suitable monofunctional acrylate monomers are commercially available under the denominations SR-531, SR-789 from Sartomer. The polyfunctional (meth)acrylate monomers may be selected from the group consisting of butanediol di(meth)acrylate, hexanediol di(meth)acrylate, diethylene glycol di(meth)acrylate, triethyleneglycol di(meth)acrylate, polyethylene glycol di(meth)acrylate, trimethylolpropane tri(meth)acrylate (TMPTA), ethoxylatedtrimethylolpropane tri(meth)acrylate, neopentylglycoldiacrylate, pentaerythritoltetraacrylate (PETA), pentaerythritoltetramethacrylate (PETMA), dipentaerythritolpenta(meth)acrylate, dipentaerythritolhexa(meth)acrylate, bisphenol-A-diacrylate, bisphenol-A-dimethacrylate, ethoxylatedbisphenol-A-diacrylate, propoxylatedbisphenol-A-diacrylate, and mixtures thereof. Polyfunctional (meth)acrylic esters may be of relatively low molecular weight such as the commercially available, triethylene oxide dimethacrylate, or butanedioldimethacrylate, or may be of higher molecular weight: (meth)acrylic functionalized oligomers and (meth)acrylic functionalized resins, for example (meth)acrylic ester terminated polymers, such as (meth)acrylic terminated polyesters or urethane polymers or copolymers or so-called (meth)acrylic ester functionalised telechelic, dendrimeric or hyperbranched materials. Suitable (meth)acrylic monomers are commercially available from Sartomer, Arkema and BASF, such as for example SR-341, SR-508 and SR-834 from Sartomer.

The liquid resin may comprise from 5 to 50% by weight of additional photopolymerizable monomers, by total weight of the mixtures of photopolymerizable monomers.

In an alternative embodiment, the liquid resin may be substantially free of photopolymerizable monomers other than cyanoacrylate-based monomers. By “substantially free of” is meant a liquid resin comprising 1% by weight or less, preferably 0.1% by weight or less, more preferably 0.01% by weight or less, most preferably 0% by weight (free), of additional photopolymerizable monomers by total weight of the liquid resin.

Resin-Immiscible Liquid

A resin-immiscible liquid may be provided.

This liquid is immiscible to the liquid resin, particularly to the cyanoacrylate-based monomers.

When present, the resin-immiscible liquid is held in the tank, and both the liquid resin and the resin-immiscible liquid forms a bilayer volume, wherein the latter is below the former.

The resin-immiscible liquid may comprise acidic inhibitors or be inherently acidic.

Acidic Inhibitors

The printing system comprises a source of acidic inhibitors, for providing acidic inhibitors to the liquid resin.

In the present application the terms “acidic inhibitors”, “inhibitors of photopolymerization” and “stabilizers against photopolymerization” are used interchangeably. The acidic inhibitors aim at stabilizing the liquid resin comprising the cyanoacrylate-based monomers, thus avoiding unwanted polymerization, absent from any light exposure, and also for maintaining prevention of the polymerization outside the polymerization zone i.e. in the remaining part of the liquid resin where no polymerization is expected (for example in the dead zone of CLIP methods or within projected patterns of volumetric methods).

The acidic inhibitors may be selected from the group consisting of Lewis acids, Bronsted acids, acids provided from an acidic ion exchange material or photoacids obtained from photoacid generators (also known as PAGs).

Lewis acids are non-protonic acids, which may be selected from the group consisting boron trifluoride and derivatives, fluoroboric acid, sulphur dioxide, and mixtures thereof; preferably from the group consisting of boron trifluoride, boron trifluoride etherate complex, boron trifluoride dihydrate complex, boro trifluoride tetrahydrofuran complex, trimethylsilyl triflate, sulphur dioxide, and mixtures thereof; more preferably the Lewis acid is etherate complex. In some embodiments, Lewis acids preferably are volatile acids such as boron trifluoride or its complexes or sulphur dioxide.

Bronsted acids may be selected from the group consisting of alkyl sulfonic acids such as methanesulfonic acid, ethanesulfonic acid, p-toluenesulfonic acid, (linear or) alkylbenzene sulfonic acid, hydrofluoric acid, trichloro- or trifluro-acetic acids; preferably sulfonic acids; more preferably methane sulfonic acid.

Acids provided from an acidic ion exchange material, such as a membrane, may be in the form of free sulfonic acids. Hence, the cyanoacrylate-based monomers may be inhibited by intimate contact with a separate substance comprising sulfonic acids groups during the printing method.

Photoacid generators may be selected from the group consisting of phenyl-substituted onium salts, arylsulfonate esters, o-nitrobenzyl-based PAG, imino and imidosulfonates, merocyanine-based PAG, terarylene-based PAG, and mixtures thereof. Phenyl-substituted onium salts, with anions that produce superacids, may be selected from the group consisting of bis(4-tert-butylphenyl)iodonium hexafluorophosphate, cyclopropyldiphenylsulfonium tetrafluoroborate, dimethylphenacylsulfonium tetrafluoroborate, diphenyliodonium hexafluorophosphate, diphenyliodonium hexafluoroarsenate, diphenyliodonium trifluoromethane sulfonate, 4-isoproyl-4′-methyldiphenyliodonium tetrakis(pentafluorophenyl)borate, 4-nitrobenzenediazonium tetrafluoroborate, triphenylsulfonium tetrafluoroborate, tri-p-tolylsulfonium hexafluorophosphate, tri-p-tolylsulfonium trifluoromethanesulfonate, bis(4-tert-butylphenyl)iodonium bis-perfluorobutanesulfonyl imide. Suitable Photoacid generators may be available from Fujifilm Wako Pure Chemical Co., and TCI America Chem Co. Bis(4-tert-butylphenyl)iodonium hexafluorophosphate is commercially available under the denomination Speedcure® 938 from Lambson Ltd. In a preferred embodiment, phenyl-substituted onium salts can be used in the wavelength range of 350-2500 nm when used alone and/or in combination with photosensitizers (see examples in Progress in Polymer Science; Volume 65, February 2017, Pages 1-41). Hence, the cyanoacrylate-based monomers may be inhibited by the purposeful photogeneration of inhibiting acid during the printing process, particularly by ensuring that the wavelengths for photopolymerization and photoinhibition are non-interfering.

The acidic inhibitors may be provided in any suitable manner. The source of acidic inhibitors may be present originally in the liquid resin, it may be located below the tank but be accessible to the tank contents, it may be inside the below compartment of the tank, it may be inside a liquid or wettable optically transparent material or it may be inside a resin-immiscible liquid. These different sources of acidic inhibitors are not necessarily exclusive from each other and may be used in combination. Whatever the sources of acidic inhibitors and their location, the acidic inhibitors should be provided to the liquid resin at a sufficient concentration for stabilizing the cyanoacrylate-based monomers and for preventing unwanted polymerization, prior to light exposure and also outside the polymerization zone under light exposure.

The liquid resin comprises acidic inhibitors. In a preferred embodiment, the liquid resin comprises from 5 from 100 parts per million (ppm), more preferably from 8 from 90 ppm, still more preferably from 10 from 80 ppm, of acidic inhibitor by total weight of the liquid resin. When present in the liquid resin, the acidic inhibitors may be selected from Lewis acid, Bronsted acids or combinations thereof.

The acidic inhibitors are present originally in the liquid resin as a sole or primary source of acidic inhibitors. The presence of acidic inhibitors as the sole source of acidic inhibitors is particularly suitable for volumetric 3D printing methods. The presence of acidic inhibitors as a primary source of acidic inhibitors is particularly suitable for continuous linear 3D and layer-by-layer printing methods.

The system may comprise a secondary source of acidic inhibitors i.e. a source of acidic inhibitors being different from the acidic inhibitors originally present in the liquid resin.

The acidic inhibitors may diffuse to the volume of liquid resin from/through a semipermeable membrane. The semipermeable membrane may be the optically transparent portion. In such case, the source of acidic inhibitors would be located below the tank. The semipermeable membrane may alternatively be a partition wall, if present. In such case, the source of acidic inhibitors would be located inside the lower compartment of the tank. In these embodiments, the acidic inhibitors may be volatile Lewis acids. Hence, the cyanoacrylate-based monomers are inhibited by the vapour of the Lewis acid during the printing process.

The acidic inhibitors may be in contact with the volume of liquid resin from a liquid or wettable, optically transparent material overlying the inner surface of the optically transparent portion of the tank.

A resin-immiscible liquid, also held in the tank, may be provided. The acidic inhibitors may be in contact with the liquid resin at the interface with the resin-immiscible liquid.

An additional light, of a different wavelength than the light selectively polymerizing the liquid resin, may be emitted and transmitted to the liquid resin comprising for example latent PAGs, and the acidic inhibitors may be thus generated in the volume elements (voxels) of liquid resin by said additional light.

Photoinitiation

The liquid resin comprises a source of photoinitiators. Photoinitiators promote photopolymerization. The terms “photointiator” and “photoinitiator system” are used interchangeably presently. A suitable photoinitiator system, part of which comprises radical photoinitiators, is disclosed in the PCT application WO 2017/021785 A1. Photoinitiators may also act directly on any additional photopolymerizable monomers, such as typical acrylates, that may be admixed with cyanoacrylate-based monomers in the liquid resin.

A suitable source of photoinitiators comprises a metallocene component (also called “synergist”), preferably a metallocene compound selected from the group consisting of ‘sandwich compounds’ such as ferrocene compounds, ruthenocene compounds, bis(cyclopentadienyl) osmium compounds their derivatives thereof, and mixtures thereof; preferably the metallocene compound is a ferrocene compound, its derivatives thereof, and mixtures thereof.

The ferrocene compound of formula may be a compound of formula (V)

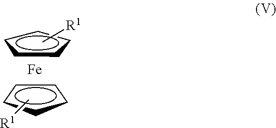

wherein R¹ is a hydrogen or a C₁₋₄ alkyl group, and wherein one or more R¹ are present in one or both rings. Suitable ferrocene compounds are disclosed in U.S. Pat. Nos. 5,824,180 and 6,503,959.

The liquid resin may comprise from 100 to 1000 ppm (parts per million), preferably from 150 to 500 ppm, more preferably from 200 to 300 ppm, of a ferrocene compound of formula (V) by total weight of the liquid resin.

This suitable source of photoinitiators also comprises an additional photoinitiator.

The additional photoinitiator may be selected from the group consisting of phenyl-substituted acyl phosphines, alpha diketones, thioxanthones, alpha-hydroxy ketones, benzyldimethylketals, phenylglyoxylates, camphorquinone, acylgermane compounds, dialkylsilylglyoxylates, and mixtures thereof. The additional photoinitiators are particularly useful for increasing the speed of the polymerization of the cyanoacrylate-based monomers.

The acylgermane compound may be selected from the group consisting of the compounds of formula (VI)

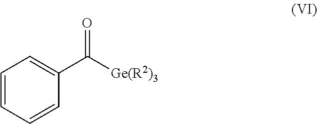

wherein R² is a methyl or a phenyl group;

the compounds of formula (VII)

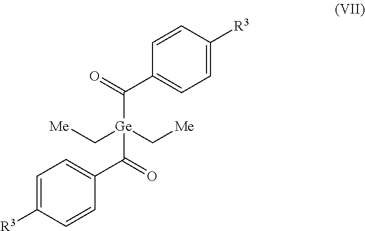

wherein R³ is hydrogen or a methoxy group; and,

mixtures thereof.

Suitable additional photoinitiators are commercially available under the denominations Irgacure® 819 (BASF) or Darocur® TPO (BASF) for phenyl-substituted acyl phosphines; Irgacure® 184/500/2959 (BASF) or Darocur® 1173 (BASF) for alpha-hydroxy ketones; Irgacure® 651 (BASF) for benzyldimethylketals, Irgacure® 754 (BASF) or Darocur® MBF (BASF) for phenylglyoxylates; from Sigma-Aldrich Merck for camphorquinone; under the denomination Ivocerin™ from Ivoclar KGaA & AC Co. for acyl germane compounds; and from Sigma-Aldrich Merck for dialkylsilylglyoxylates.

In a preferred embodiment, the liquid resin comprises the combination of metallocene compounds and radical photoinitiators. Said combination transforms photoinitiation efficiency dramatically.

In another preferred embodiment, the liquid resin comprises a ferrocene compound of formula (V), and an acylgermane compound selected from the group consisting of the compounds of formulas (VI) and/or (VI); preferably the liquid resin comprises from 100 to 300 ppm of a ferrocene compound of formula (V), and from 600 to 900 ppm of an acylgermane compound selected from the group consisting of the compounds of formulas (VI) and/or (VI).

In another preferred embodiment, the liquid resin comprises a ferrocene compound of formula (V), and a camphorquinone.

The liquid resin may comprise from 0.1 to 2% by weight, preferably from 0.5 to 2% by weight, more preferably from 1 to 2% by weight, of an additional photoinitiator by weight of the total composition.

Additional Compounds

The liquid resin may also comprise additional compounds, particularly compounds selected from the group consisting of radical stabilizers, photosentizers, etc.

Radical Stabilizers

The liquid resin may also comprise radical stabilizers.

The radical stabilizers may be selected from the group consisting of hydroquinone, hydroquinone monomethyl ether, hydroxytoluene butyl ether, hydroxyanisole, and mixtures thereof. Radical stabilizers help extending product shelf life, particularly when additional photopolymerizable monomers, such as (meth)acrylate monomers are present in the liquid resin

The liquid resin may comprise from 0.001% to 0.2% by weight, preferably from 0.005% to 0.1%, more preferably from 0.002% to 0.06% by weight, of radical stabilizers by total weight of the liquid resin.

Photosensitizers

The liquid resin may also comprise a photosensitizer.

The photosensitizer may be thioxanthone compound. Suitable materials are commercially available under the denomination SpeedCure CPTX from Lambson Ltd. For example, 1-chloro-4-propyl thioxanthone is a suitable compound, that is sensitive in a wavelength range from 380 to 420 nm, preferably from 395 to 405 nm. It can be used in combination with bis(4-tert-butylphenyl)iodonium hexafluorophosphate.

The liquid resin may comprise from 0.1% to 5% by weight, preferably from 0.2% to 3%, more preferably from 0.5% to 2.5% by weight, of photosensitizers by total weight of the liquid resin.

Thickeners

The liquid resin may also comprise thickeners. Thickeners are particularly suitable for controlling and/or increasing the viscosity of the liquid resin, considering that cyanoacrylate-based monomers usually have a water-like viscosity at ambient temperature.

Suitable thickeners may be selected from the group consisting of poly(meth)acrylates, acylated cellulose polymers (e.g. cellulose acetate), polyvinyl acetates, partially hydrolysed polyvinyl acetates, polyvinylpyrrolidones, polyoxylates, polycaprolactones, polycyanoacrylates, vinyl acetate copolymers (e.g. with vinyl chloride), copolymers of (meth)acrylates with butadiene and styrene, copolymers of vinyl chloride and acrylonitrile, copolymers of ethylene and vinyl acetate, poly(butyleneterephthalate-co-polyethyleneglycolterephthalate), copolymers of lactic acid and caprolactone, and mixtures thereof.

Preferably, the thickeners are selected from the group consisting of polymethylmethacrylate, polycyanoacrylates, copolymers of vinyl acetate and vinyl alcohol, copolymers of vinyl chloride and vinyl acetate, copolymers of ethylene, vinyl acetate, and esters or partial esters of maleic acid, and mixtures thereof. Suitable materials are commercially available under the denomination Degacryl® M 449 from Evonik (polymethylmethacrylate), Levamelt® 900 from Lanxess (copolymers of vinyl acetate and vinyl alcohol), Vinnol® H 40-60 from Wacker (copolymers of vinyl chloride and vinyl acetate), and Vamac® G from DuPont (copolymers of ethylene, vinyl acetate, and esters or partial esters of maleic acid).

The liquid composition may comprise from 2% to 10% by weight, preferably from 3% to 8% by weight, and more preferably from 4% to 7% by weight, of thickeners by total weight of the liquid resin.

Thixotropic Agent

The liquid resin may also comprise thixotropic agents.

The thixotropic agent may be silica, preferably fumed silica, more preferably hydrophobic fumed silica. Hydrophobic fumed silica may also acts as a filler. A hydrophobic fumed silica is commercially available under the commercial denomination Aerosil® R202 from Evonik. The thixotropic agent may also be organic-based thixotropic agents, preferably hydrogenated castor oil.

The liquid resin may comprise from 2% to 10% by weight, preferably from 3% to 8% by weight, more preferably from 4% to 7% by weight, of thixotropic agents by total weight of the liquid resin.

Fillers and Pigments

In addition to hydrophobic fumed silica if present, the liquid composition may also comprise other fillers and pigments, preferably acid-treated fillers and pigments, more preferably organo-silicone modified surface-treated pigments and fillers. Other fillers and pigments should be compatible with cyanoacrylate-based monomers and not excessively impede the photopolymerization where desired. In some cases, pigments may be used to limit excessive light penetration or ‘read through’ that could limit resolution of printed elements. U.S. Pat. Nos. 4,837,260 and 4,980,086, and US patent applications 2005/0171273 and 2008/0038218 describe cyanoacrylate-compatible fillers.

The liquid resin may comprise from 0.1 to 5% by weight of other fillers and pigments by total weight of the composition.

Toughening Agents

The liquid resin may also comprise toughening agents.

The toughening agents may be selected from the group consisting of block copolymers (e.g. polymethylmethacrylate-co-Polybutylacrylate-co-Polymethylmethacrylate, elastomeric rubbers, elastomeric polymers, liquid elastomers, polyesters, acrylic rubbers, butadiene/acrylonitrile rubber, Buna rubber, polyisobutylene, polyisoprene, natural rubber, synthetic rubber (e.g. styrene/butadiene rubber or SBR), polyurethane polymers, ethylene-vinyl acetate polymers, fluorinated rubbers, isoprene-acrylonitrile polymers, chlorosulfonated polyethylenes, homopolymers of polyvinyl acetate, block copolymers, core-shell rubber particles, and mixtures thereof.

The liquid resin may comprise from 1 to 20% by weight, preferably from 5 to 12% by weight, of toughening agents by total weight of the composition.

Plasticizers

The liquid resin may also comprise plasticizers, such a glycerol triacetate and dibutylsebacate.

The liquid resin may comprise from 5 to 20% by weight of plasticizers by total weight of the liquid resin.

Method for Printing 3D Articles

The method for printing a 3D article (or 3D printing method), according to the present invention, comprises the steps of:

a) providing a volume of liquid resin comprising cyanoacrylate-based monomers, a photoinitiator and an acidic inhibitor, held in a tank, said tank comprising at least one optically transparent portion;

b) defining/comprising a polymerization zone;

c) emitting and controlling light and transmitting it to the liquid resin through the optically transparent portion for selectively polymerizing the liquid resin in the polymerization zone; and

d) obtaining a three-dimensional article made of polymerized resin.

In an embodiment, the method for printing a three-dimensional (3D) article, comprises the steps of: a) providing a volume of liquid resin comprising cyanoacrylate-based monomers and a photoinitiator, held in a tank, said tank comprising at least one optically transparent portion; b) defining a polymerization zone; c) emitting and controlling light and transmitting it to the liquid resin through the optically transparent portion for selectively polymerizing the liquid resin in the polymerization zone; d) concurrently preventing the polymerization of the monomers using acidic inhibitors outside the polymerization zone; and e) obtaining a three-dimensional article made of a polymerized resin. In an embodiment, the three-dimensional printing system comprises: a) a volume of liquid resin comprising cyanoacrylate-based monomers and a photoinitiator, said volume defining a polymerization zone; b) a tank for holding the volume of liquid resin, said tank comprising at least one optically transparent portion; c) a light source emitting light for selectively polymerizing the liquid resin in the polymerization zone; and d) a source of acidic inhibitors for preventing the polymerization of the monomers outside the polymerization zone.

The liquid resin, the cyanoacrylate-based monomers, a photoinitiator systems, the acidic inhibitors and any other materials are described above. The presence of the acidic inhibitors in the liquid resin (as the sole or as a primary source of acidic inhibitors) as well as the optional provision of a secondary source of acidic inhibitors are suitable for stabilizing the cyanoacrylate-based monomers and for preventing unwanted polymerization, prior light exposure and also outside the polymerization zone under light exposure. Hence, the provision of a volume of liquid resin comprising an acidic inhibitor and the optional provision of an additional source of acidic amounts to the provision of the step of concurrently preventing the polymerization of the monomers using acidic inhibitors outside the polymerization zone i.e. under light exposure.

In some embodiments, such as layer-by-layer printing methods and continuous printing methods including CLIP and ILI methods, the optically transparent portion corresponds to the bottom wall of the tank, and the light is emitted from below the tank, through its bottom surface, into the volume resin. A platform, preferably moveably mounted on an arm, is provided from above the tank, and is submerged into the volume of liquid resin. The bottom surface of the platform is positioned at a specific distance above the top surface of the optically transparent portion, thereby forming a space comprised of liquid resin.

The 3D printing method may comprise the following additional steps. Some of these steps may depend on specific methods and/or conditions, as indicated herein before.

The method may comprise the step of providing a tank comprising an optically transparent portion and forming at least one compartment for holding the liquid resin.

The method may comprise the step of rotatably moving the tank in the vertical Z axis.

The method may comprise the step of treating the inner surface of the optically transparent portion, in contact with the liquid resin, for preventing adhesion of the polymerized resin to it.

The method may comprise the step of controlling the emission of the light using a light-controlling device. Particularly, the method may comprise the step of interposing the light-controlling device between the light source and the optically transparent portion.

The method may comprise the step of emitting an additional light, having a different wavelength, for photoinhibiting the polymerization.

The method may comprise the step of providing a platform moveably mounted on an arm, for enabling its motion along the vertical Z axis.

The method may comprise the step of providing an additional source of acidic inhibitors.

The method may comprise the step of diffusing the acidic inhibitor to the volume of liquid resin through the optically transparent portion, or alternatively through the partition wall.

The method may comprise the step of overlying the inner surface of the optically transparent portion of the tank with a liquid or wettable, optically transparent material. The method may further comprise the step of releasing the acidic inhibitor to the volume of liquid resin from the liquid or wettable, optically transparent material.

The method may comprise the step of providing a resin-immiscible liquid. The method may further comprise the step of releasing the acidic inhibitor to the volume of liquid resin from the resin-immiscible liquid.

The method may comprise the step of photogenerating the acidic inhibitor in the volume of liquid resin.

The method may comprise the step of providing a source of photoinitiators to the liquid resin comprising the combination of metallocene compounds and radical photoinitiators.

The 3D printing method may be computer-implemented in a conventional manner. This means that steps (or substantially all the steps) of the method are executed by at least one computer, or any system alike. Thus, steps of the method are performed by the computer, possibly fully automatically, or, semi-automatically. In examples, the triggering of at least some of the steps of the method may be performed through user-computer interaction. The level of user-computer interaction required may depend on the level of automatism foreseen and put in balance with the need to implement user's wishes. In examples, this level may be user-defined and/or pre-defined. For example, depending on the embodiments, the light intensity, the control of the light, the elevation of the platform, the rotation of the tank, the provision of the liquid resin and/or the provision of the acidic inhibitor may be executed by at least one computer, or any system alike.

Layer-by Layer 3D Printing Methods

The so-called “bottom-up” layer-by-layer 3D printing method may comprise the following steps:

a) providing a fixed tank comprising a bottom wall and at least one side wall forming a compartment, wherein at least one optically transparent portion is located on the bottom wall;

b) providing a volume of liquid resin comprising cyanoacrylate-based monomers, a photoinitiator system, and an acidic inhibitor, held in the tank;

c) providing a light source located below the tank;

d) optionally providing an additional source of acidic inhibitor;

e) providing a platform, immersing it in the liquid resin, and positioning its bottom surface at a specific distance from the optically transparent portion of the tank;

f) continuously exposing the liquid resin to light according to a defined pattern for defining a polymerization zone;

g) concurrently moving the platform upwards along the Z axis allowing the liquid resin to flow between the bottom layer of the first layer and the top surface of the optically transparent portion and then lowering the platform downwards to the specific distance between the bottom surface of the platform and the top surface of the optically transparent portion for photopolymerizing the first layer of the 3D article;

h) repeating step f) for photopolymerizing additional layers for printing the 3D article; and

i) obtaining a three-dimensional article made of polymerized resin.

Continuous Linear 3D Printing Methods

The continuous linear 3D printing methods may be selected from CLIP methods or ILI methods.

Continuous linear 3D printing methods such as CLIP and ILI methods may comprise the following steps:

a) providing a fixed tank comprising a bottom wall and at least one side wall forming a compartment, wherein at least one optically transparent portion is located on the bottom wall;

b) providing a volume of liquid resin comprising cyanoacrylate-based monomers, a photoinitiator system, and an acidic inhibitor, held in the tank;

c) providing a light source located below the tank;

d) optionally providing an additional source of acidic inhibitor;

e) providing a platform, immersing it in the liquid resin, and positioning its bottom surface at a specific distance from the optically transparent portion of the tank;

f) continuously exposing the liquid resin to light according to a defined pattern for defining a polymerization zone;

g) concurrently moving the platform upwards at a specific elevation rate for progressively photopolymerizing the liquid resin; and

h) optionally removing the liquid resin in excess with an absorbent paper.

In a preferred embodiment, a dead zone is formed, which is sandwiched between the optically transparent portion and the polymerization zone. The dead zone is the zone in contact with the optically transparent portion, wherein the resin does not polymerize, even when exposed to light. In addition of conventional means such as coatings as well as the acidic inhibitors present in the liquid resin, the dead zone may further be obtained by providing the additional source of acidic inhibitors. When the method comprises the step of providing an additional source of acidic inhibitors, the tank may comprise a partition wall, such as a semi-permeable membrane, for dividing the tank into two compartments i.e. a top compartment and a bottom compartment. Alternatively, the inner surface of the optically transparent portion of the tank may be overlaid with a liquid or wettable, optically transparent material, such as a membrane. Alternatively, the tank may further comprise a resin-immiscible liquid. In such case, the provision of the additional acidic inhibitors from the bottom of the compartment holding the liquid resin (e.g. the optically transparent portion, a semipermeable membrane, a surface of the liquid or a wettable, optically transparent material or the resin-immiscible liquid) creates a gradient of acidic inhibitors, thereby inhibiting the photoinhibition in the vicinity of the bottom of the compartment holing the liquid resin, in an analogous way to oxygen used in conventional 3D printing methods relying on radical photopolymerization.

Volumetric 3D Printing Methods

Volumetric 3D printing methods may comprise the following steps:

a) providing a tank, rotatably moveable around a vertical Z axis, comprising a bottom wall and at least one side wall forming a compartment, wherein at least one optically transparent portion is located on the side wall of the tank;

b) providing a volume of liquid resin comprising cyanoacrylate-based monomers, a photoinitiator system, and an acidic inhibitor, held in the tank;

c) providing a light source located at least on one the side of the tank;

d) optionally providing an additional source of acidic inhibitor;

e) exposing the liquid resin to at least a first set of light, either continuously or at a specific sequence for progressively photopolymerizing the liquid resin;

f) concurrently rotating the tank at a at a specific rotation rate; and

g) obtaining a three-dimensional article made of polymerized resin.

The volumetric 3D printing methods are selected from the CAL method or the dual-wavelength volumetric photopolymerization method.

In a preferred embodiment, the volumetric 3D printing method does not comprise the step of providing an additional source of acidic inhibitors.

3D Printed Articles

3D printed articles are obtained by the present 3D printing method.

The 3D printed article, according to the present invention, is made, at least partly, of polycyanoacrylate. The 3D printed article may comprise from 50% by weight of polycyanoacrylate, by total weight of the article. The 3D printed article may comprise from 55%, or from 60%, or from 65%, or from 70%, or from 75%, or from 80%, or from 85%, or from 90%, or from 95% by weight of cyanoacrylate by total weight of the article. The 3D printed article may comprise up to 95% by weight of polycyanoacrylate, by total weight of the article. The 3D printed article may comprise up to 90%, or up to 85%, or up to 80%, or up to 75% by weight of polycyanoacrylate, by total weight of the article. In one embodiment, the 3D printed article may be substantially free of another polymer other than polycyanoacrylate. By “substantially free of” is meant an article comprising 1% by weight or less, preferably 0.1% by weight or less, more preferably 0.01% by weight or less, most preferably 0% by weight (free), of another polymer other than polycyanoacrylate.

By “3D printed articles” is meant unmoulded articles. By “polycyanoacrylate” is meant homopolymer(s) obtained from the polymerization of distinct cyanoacrylate-based monomers, or copolymers of mixed cyanoacrylate-based monomers. Optionally additional photopolymerizable monomers, such as (meth)acrylate monomers may copolymerise with cyanoacrylate-based monomers.

The polymerised resin may comprise any additional compounds, such as fillers, pigments, plasticizers, etc.

The 3D printed articles may be of any shape, design and aesthetical aspect, considering the great versatility of the present 3D printing methods. In particular, the 3D printed articles are unstratified articles, even when manufactured from layer-by-layer 3D printing methods. In addition, the 3D articles are tack-free articles. By “tack-free” is meant that the article does not exhibit the so-called surface air inhibition, which is common in photoradical polymerization.

### EXAMPLES

### Example 1—Printing of a Three-Dimensional Article Using a “Bottom-Up” “Layer-by-Layer” Method

3D articles are printed using a “bottom-up” “layer-by-layer” method according to the protocol and conditions detailed below.

Device: LCD Photon 3D Printer, Anycubic

3D article to be printed: Main body being a rectangular block of 35 mm (length)×15 mm (width)×5 mm (thickness in the Z axis), with a base of 0.8 mm (thickness)

Light wavelength: 405 nm

Light exposure (base): 60 sec

Light exposure (main body): 30 sec

LCD mask: Yes

Printing protocol: The 3D article is printed by sequentially carrying out the following steps:

a) immersing the platform in the liquid resin, and positioning its bottom surface at 0.1 mm height from the top surface of the optically transparent portion of the tank;

b) exposing the liquid resin to light for 60 sec through the LCD mask for photopolymerizing the first layer of the base;

c) switching off the light and moving the platform 10 mm-upwards along the Z axis for allowing the liquid resin to flow between the bottom layer of the first layer and the top surface of the optically transparent portion;

d) lowering downwards the bottom surface of the platform to about 0.2 mm from the top surface of the optically transparent portion;

e) repeating steps b) to d) seven times for photopolymerizing additional layers and for obtaining the base of the 3D article

f) exposing the liquid resin to light for 30 sec through the LCD mask for photopolymerizing the first layer of the main body;

g) sequentially carrying out steps c) to e);

h) repeating steps f) and g) for obtaining a 5 mm-tick main body; and

i) removing the liquid resin in excess with an absorbent paper.

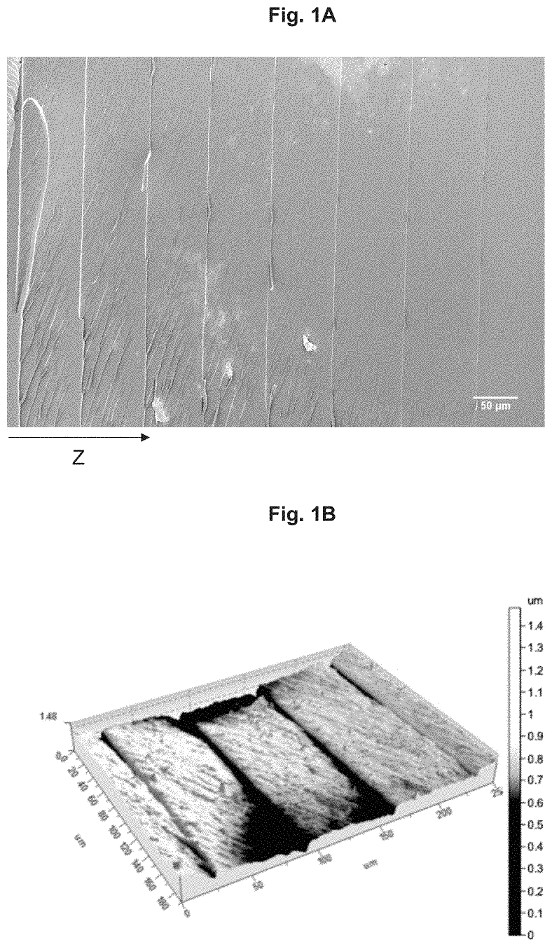

In a first experiment (comparison), a 3D article is printed according to the above protocol from a commercial liquid acrylate resin (Anycubic UV Resin, translucent green). The 3D article obtained exhibits a first wet and then tacky surface, even after further exposing with an LED torch operating at 405 nm for several minutes. Eventually the surface becomes tack free but only after about 48 hours. It is believed that the tackiness results from air inhibition of the photopolymerization of the acrylate monomers on the surface of the 3D article. The side of the 3D article, corresponding to the thickness on the Z axis, is examined by electron microscopy and with an optical contour mapping method, the latter basically examines the topography of the sample and highlights zones where deformations occur. A photograph (scale of 50 μm) of a section of the thickness obtained by electron microscopy is shown in FIG. 1A. A photograph of a section of the thickness obtained by optical contour mapping method is shown in FIG. 1B. The stratification of layers of about 70 μm in thickness along the Z axis is noticeable both under electron microscopy and optical contour mapping. However, layer stratification imparts anisotropy of mechanical properties, which is not wanted.

In a second experiment, three 3D articles are printed according to the above protocol, from three different liquid cyanoacrylate resins i.e. a resin comprising cyanoacrylate-based monomers, as detailed in table 1 (unit: weight percentage per total weight of the resins).

TABLE 1

| Components | Resin 1 | Resin 2 | Resin 3 |
|---|---|---|---|
| 2-methoxyethyl | q.s. 100% | q.s. 100% | q.s. 100% |
| cyanoacrylate | (about 99.9%) | (about 94.3%) | (about 94.9%) |
| Polymethyl | — | 5.6% | n/a |
| methacrylate | | | |
| Hydrophobic | — | — | 5.0% |
| fumed silica | | | |
| Acylgermane | 0.075% | 0.075% | 0.075% |
| Structure | | | |
| (VII) R₃ = —OCH₃ | | | |
| “Ivocerin ®” | | | |
| Ferrocene | 0.02% | 0.02% | 0.004% |
| BF₃•Et₂O | 70 ppm | 70 ppm | 10 ppm |

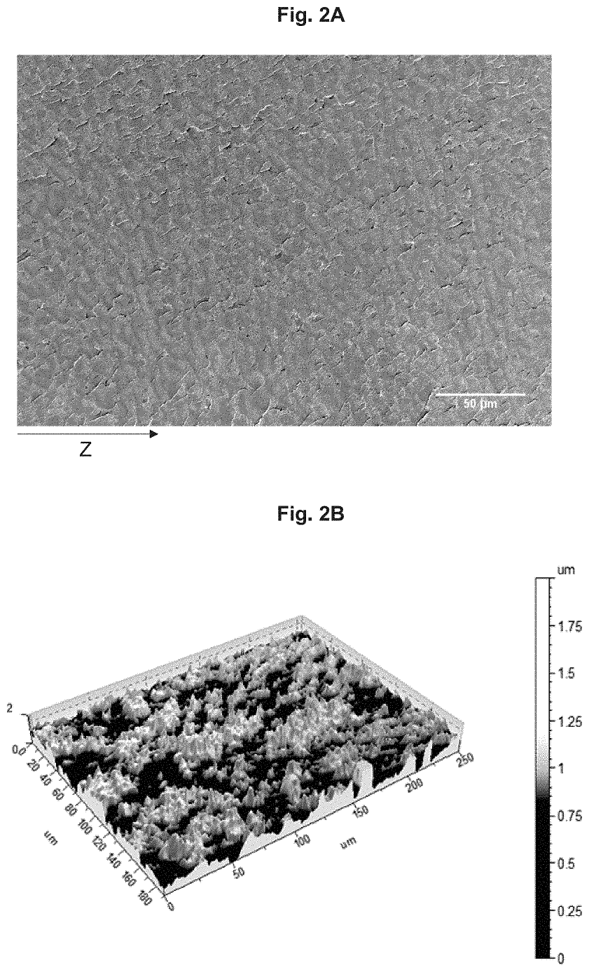

The printed 3D articles exhibit a surface-wetness due to extraction from a liquid bath, but this is easily transformed, for example by further irradiating the article using a LED torch operating at 405 nm before separated the part from the platform. The thus printed and exposed articles were track free in less than a minute. A photograph (scale of 50 μm) of a section of the thickness obtained by electron microscopy is shown in FIG. 2A. A photograph of a section of the thickness obtained by optical contour mapping method is shown in FIG. 2B. No stratification of layers along the Z-axis is noticeable under electron microscopy and optical contour mapping.

### Example 2—Inhibition of the Photopolymerization of a Liquid Cyanoacrylate Resin Using a Volatile Acidic Inhibitor

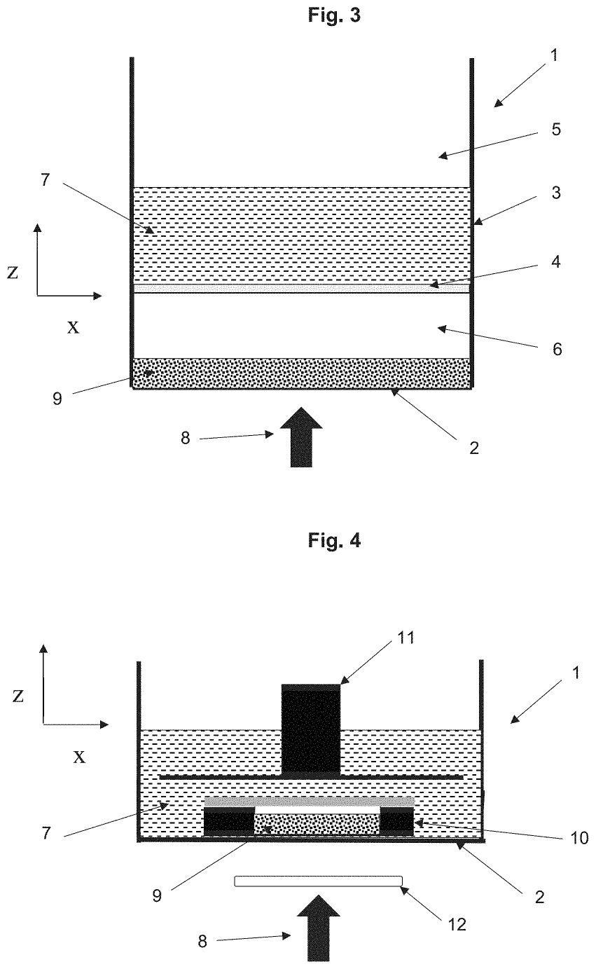

A schematic representation of the device as used in the second experiment in shown in FIG. 3.

The tank 1 comprises an optically transparent, non-permeable bottom wall 2 and non-transparent side walls 3. The tank 1 is divided in two compartments by a horizontal, optically transparent partition wall 4 i.e. a top open compartment 5 for holding the volume of the liquid resin 7, and a bottom closed compartment 6 for holding the acidic inhibitor. The partition wall 4 is made from the transparent Nafion 212 gas-permeable membrane from Fuel Cell Store Ltd. The light 8 can be transmitted through the bottom wall 2 and the partition wall 4 of the tank 1.

Liquid resin: Resin 2 according to table 1

Light source: LED with an irradiance of 30 mW/cm²

Light wavelength: 410 to 415 nm

Light exposure: 15 sec

Light emission: From bottom the tank

Acidic inhibitor: Liquid Lewis acid complex BF₃.Et₂O from Sigma-Aldrich

In a first experiment (control), no acidic inhibitor is added to the lower compartment 6 of the tank 1, which only comprises dry air. Air oxygen diffuses through the partition wall 4. Upon light exposure, the liquid resin 7 photopolymerizes on the top surface of the partition wall 4. Hence, no “dead zone” is created in the vicinity of the top surface of the partition wall 4 and the polymerized resin adheres to it, which is unwanted.

In a second experiment, 1 ml of the liquid solution of acidic inhibitor 9 is added to the bottom compartment 6 of the tank 1. There is no contact between the liquid solution 9 and the partition wall 4, the surface of the liquid solution 9 being 4 cm below the partition wall 4. As the Lewis acid complex BF₃.Et₂O is volatile, it evaporates into the dry air, and diffuses through the partition wall 4. No compressors or gas handling or conveying equipment for gases is used or needed. Upon light exposure, the liquid resin 7 photopolymerizes only above an unpolymerized liquid layer atop the surface of the partition wall 4, forming a “dead zone”.

This example demonstrates that the diffusion of volatile acidic inhibitors through a semi-permeable membrane is suitable for inhibiting the photopolymerization of cyanoacrylate-based monomers. This is particularly useful in CLIP methods, for creating a “dead zone” atop the optically transparent portion of the tank, hereby preventing the adhesion of the polymerized resin to the tank.

### Example 3—Printing of a Three-Dimensional Article Using a CLIP Method

A schematic representation of the system is shown in FIG. 4.

Device: LCD Photon 3D printer, Anycubic with a modified light source

Liquid resin: Resin 1 according to table 1

Light source: 100 LEDs with an irradiance of about 3 mW/cm²

Light wavelength: 450 nm

Acidic inhibitor: Liquid Lewis acid complex BF₃.Et₂O from Sigma-Aldrich

Initial light exposure (base layer): 60 sec

Light exposure (main body): total of 3,000 sec

LCD mask: Yes

Platform elevation (main body): Continuous rate of 100 μm per 60 sec

The device is adapted by placing into the tank 1, on top of the optically transparent portion 2, a resin-impermeable chamber 10 having a volume of 4 cm×3 cm×0.5 cm. A volume of 0.1 mL of a liquid solution of acidic inhibitor 9 is poured into the chamber 10, and the chamber 10 is then tightly closed with a transparent Nafion 212 gas-permeable membrane from Fuel Cell Store Ltd, leaving a headspace between the liquid solution 9 and the membrane, for the volatile acidic inhibitor to evaporate. The liquid resin 7 is poured into the tank 1, in order to fully submerge the chamber 10. The platform 11 is then lowered into the liquid resin 7 to a print-starting position 4.0 mm above the membrane. Upon an initial light exposure through a mask 12, a 0.1 mm-thick base layer adhering to the platform 11 is polymerized (not shown). Upon further light exposure, the platform 11 is continuously elevated, and the main body is progressively formed (not shown). Upon completion of the photopolymerization, the resin in excess is removed, and the 3D article is rendered tack-free by further irradiating the article using a LED torch operating at 405 nm before being separated from the platform 11.

This experiment confirms that no polymerization occurs in the vicinity of the top surface of the membrane, wherein a “dead zone” is formed, by the diffusion of the volatile acidic stabiliser through the membrane, hereby preventing the adhesion of the polymerized resin to the tank.

### Example 4—Inhibition of the Photopolymerization of a Liquid Cyanoacrylate Resin Using a Transparent Wettable Material Such as a Membrane

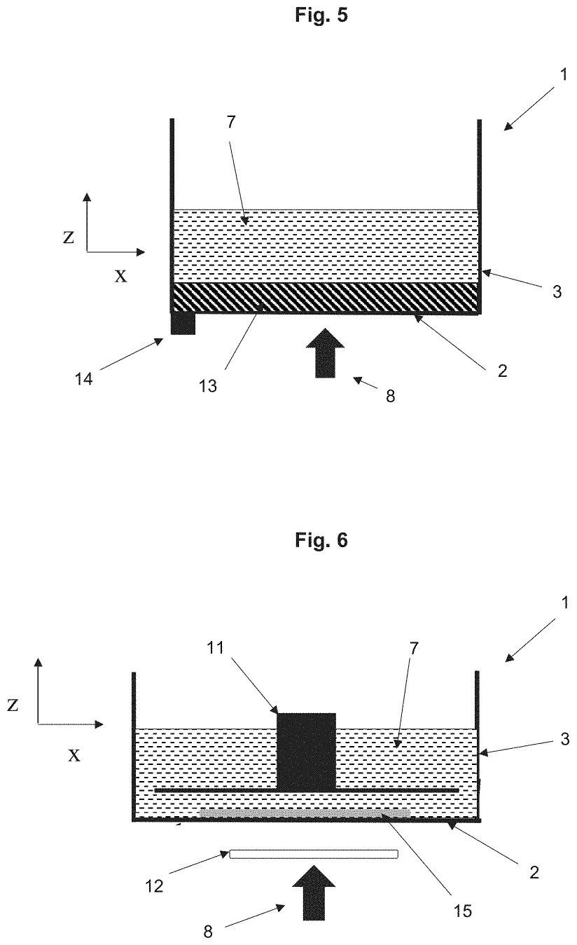

A schematic representation of the tank in shown in FIG. 5.

Transparent wettable membrane: Hydrogel contact lens material comprising hydroxymethacrylate/N-vinyl pyrrolidone copolymer commercialised under the denomination SofLens Hilafilcon from Bausch & Lomb Ltd

Liquid resin: Resin 2 according to table 1

Light source: LED with an irradiance of about 30 mW/cm²

Light wavelength: 410 to 415 nm

Acidic inhibitor: Aqueous solution of phosphoric acid (2M)—Bronsted acid

Light exposure (control): 15 sec

Light exposure: 30 sec

LCD mask: Yes

The tank 1 comprises an optically transparent, non-permeable bottom wall 2 and non-transparent side walls 3. A transparent wettable membrane 13 is placed on top of the optically transparent portion 2 of the tank 1.

In a first experiment (control), the membrane 13 is fed with ultrapure water, free of any acidic inhibitor, which is continuously supplied from a reservoir 14. The tank 1 is filed with liquid resin 7, which is immiscible into water. Upon light exposure 8, the liquid resin 7 photopolymerizes on the membrane 13, and adheres to it. Hence, no “dead zone” is created in the vicinity of the top surface of the membrane 13 and the polymerized resin adheres to it, which is unwanted.

In a second experiment, the membrane 13 is fed with an aqueous solution of H₃PO₄ as an acidic inhibitor, which is continuously supplied from a reservoir 14. The tank 1 is filed with a liquid resin 7, which is immiscible into the acidic inhibitor solution. Upon light exposure 8, the liquid resin 7 polymerizes only above an unpolymerized liquid layer having a thickness of about 0.5 mm atop the surface of the membrane 13, forming a “dead zone”.

This example demonstrates that the contact of the volume of liquid resin with an acidic inhibitor from a wettable, optically transparent membrane overlying the inner surface of the optically transparent portion of the tank is suitable for inhibiting the polymerization of cyanoacrylate-based monomers. This is particularly useful in ILI methods, for creating a “dead zone” atop the optically transparent portion of the tank, hereby preventing the adhesion of the polymerized resin to the tank.

### Example 5—Printing of a Three-Dimensional Article Using an ILI Method

A schematic representation of the system in shown in FIG. 6.

Device: LCD Photon 3D printer, Anycubic comprising an optically transparent portion made of fluorinated polyester with a modified light source

3D article to be printed: Main body corresponding to a rectangular block of 35 mm (length)×15 mm (width)×5 mm (thickness in the Z axis) with a 0.1 mm-thick first layer and a 1 mm-thick base

Liquid resin: Resin 1 according to table 1

Light source: 100 LEDs with an irradiance of about 3 mW/cm²

Light wavelength: 450 nm

Acidic inhibitor: 25 mm×50 mm solid transparent film of the material Fumapem F-930 ion exchange membrane from Fumatech BWT GmbH

Pretreatment: Activation of the solid transparent film by heating to 80° C. for 12 h in an aqueous solution of 5% w/w of sulfuric acid (H₂SO₄)

Initial light exposure (first layer): 60 sec

Initial light exposure (base): 600 sec

Light exposure (main body): 4,000 sec

LCD mask: Yes

Platform elevation (base): Continuous rate of 100 μm per 60 sec

Platform elevation (main body): Continuous rate of 600 μm per 60 sec

The device is adapted by placing into the tank 1 on top of the optically transparent portion 2 a solid transparent film 15, previously activated. The liquid resin 7 is poured into the tank 1, in order to fully submerge the film 15. The platform 11 is then lowered into the liquid resin 7 to a print-starting position 3.0 mm above the film 15. Upon an initial light exposure 8, a 0.1 mm-thick base layer adhering to the platform 11 is photopolymerized. Upon further light exposure 8, the platform 11 is continuously elevated, and the base and then the main body are progressively printed. Upon completion of the photopolymerization, the resin in excess is removed, and the 3D article is rendered tack-free by further irradiating the article using a LED torch operating at 405 nm before being separated from the platform 11.

This experiment confirms that no photopolymerization occurs in the vicinity of the top surface of the film, wherein a “dead zone” is formed, by the release of acidic inhibitor from the ion exchange membrane, hereby preventing the adhesion of the polymerized resin to the tank.

### Example 6—Printing of Three-Dimensional Articles Using an ILI Method

3D articles are printed according to an adapted protocol of example 5.

Liquid resin: Resin 4 according to table 2 below

TABLE 2

| Components | Resin 4 |
|---|---|
| 2-methoxyethyl | q.s. 100% |
| cyanoacrylate | (about 99.9%) |
| Acylgermane Structure (VII) | 0.075% |
| R₃ = —OCH₃ “Ivocerin ®” | |
| Ferrocene | 0.02% |
| BF₃•Et₂O | 30 ppm |

Platform elevation rate (base): about 33 μm/sec

Platform elevation rate (main body): about 50 μm/sec

In a first experiment, the LCD mask is replaced by a shutter forming a 35 mm×15 mm aperture, permitting more efficient use of the light intensity by avoiding the light-absorption by the LCD device itself. A 5 mm-thick base and then a 30 mm-thick main body are printed. The printed 3D article has perfectly regular edges.

In a second experiment, the LCD mask is replaced by a shutter forming a 10 mm-diameter circular aperture. A 5 mm-thick base and then a 95 mm-thick main body are printed. A cylindrical 3D article is obtained.

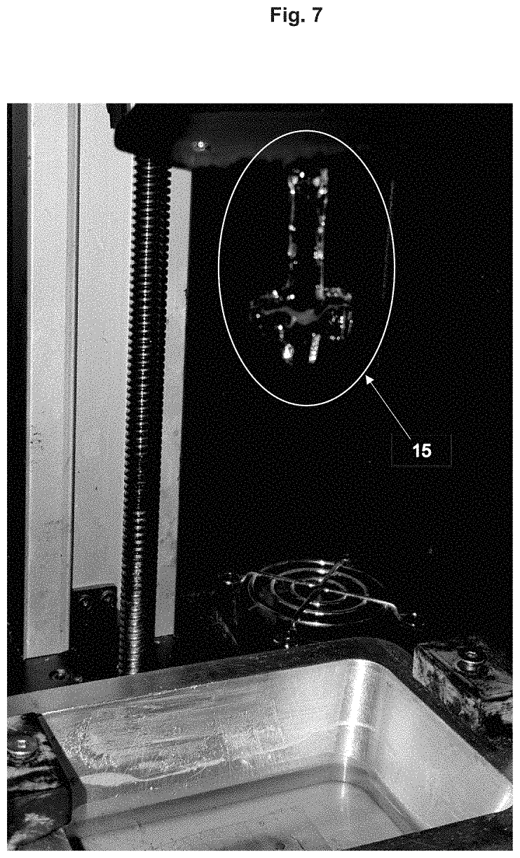

In a third experiment, the LCD mask is replaced by a shutter having a variable aperture. A 5 mm-thick base and then a cross-shaped main body are printed, by adequately adapting the aperture of the shutter during the polymerization process. A photograph of the 3D article after completion, but before separated from the platform is shown in FIG. 7. A crucifix-shape 3D article 16 is continuously printed.

In a fourth experiment, the protocol of the above first experiment is repeated, except that it is used the Resin 2 according to table 1 and a platform elevation rate of 25 μm/sec for 1,400 sec. A 35 mm×15 mm×5 mm block 3D article is obtained.

### Example 7—Photopolymerization of a Liquid Cyanoacrylate Resin Employing a Perfluorinated Liquid as Wettable Materials

Device: LCD Photon 3D printer, Anycubic with a modified light source

3D article to be printed: Main body corresponding to a rectangular block of 35 mm (length)×15 mm (width)×5 mm (thickness in the Z axis)

Perfluorinated liquid: Solution of perfluorooctane from Sigma Aldrich Ltd

Acidic inhibitor: Nonafluorobutane-1-sulfonic acid from Sigma Aldrich Ltd

Platform elevation (main body): Continuous rate of 50 μm per sec

Liquid resin: Resin 2 according to table 1

Light source: LED with an irradiance of 30 mW/cm²

Light wavelength: 410 to 415 nm

Initial light exposure (first layer): 60 sec

Initial light exposure (base): 600 sec

Light exposure (main body): 4,000 sec

Light emission: From bottom the tank through an LCD mask

In a first experiment, the device is adapted by pouring the perfluorinated liquid into the tank on top of the optically transparent portion. The liquid resin is then poured into the tank on top of the layer of perfluorinated liquid. Upon light exposure, the 3D article is printed, and no adherence to the perfluorinated liquid is observed.

In a second experiment, 0.02 g/0.5 ml of perfluorinated acidic inhibitor is added to the perfluorinated liquid, before being poured into the tank. Upon light exposure, the 3D article is also printed, and no adherence to the perfluorinated liquid is observed.

### Example 8—Characterization of Inhibition of the Polymerization of a Liquid Cyanoacrylate Resin Containing an Acidic Inhibitor

Liquid resin: Resin 1 according to table 1

Acidic inhibitor: Methane sulfonic acid (MSA) from Sigma-Aldrich

Acidic inhibitor concentrations: 0 (control), 1, 5, 10 and 40 ppm of MSA in the liquid resin

calorimeter: Device comprising an infrared sensor, that measures the temperature of a sample of polymerisable monomer as a function of time (per second) after purposely initiating polymerization under standardised conditions. The device allows characterisation of polymerization with regard to when it commences, that is when inhibition is overcome by initiation, and how exothermic the polymerization process is, once started.

The polymerization of the resin releases heat (exothermic), which can be measured using a calorimeter and represented on a graph showing the heat output due to the exotherm of the initiated polymerization (Y axis) as a function of time (Z axis). A sigmoidal curve is obtained, which rises sharply once the inhibition is overcome by the polymerization. The time necessary to overcome the inhibition is called the induction time (ti) and is dependent on both the concentrations of inhibitors and initiating species.

In these experiments, different concentrations of acidic inhibitor are added to the liquid resin and the response to the addition of a standard concentration (0.2% w/w) of a standard nucleophilic base 2-(morpholinothio)-benzothiazole, Sigma-Aldrich) is recorded.

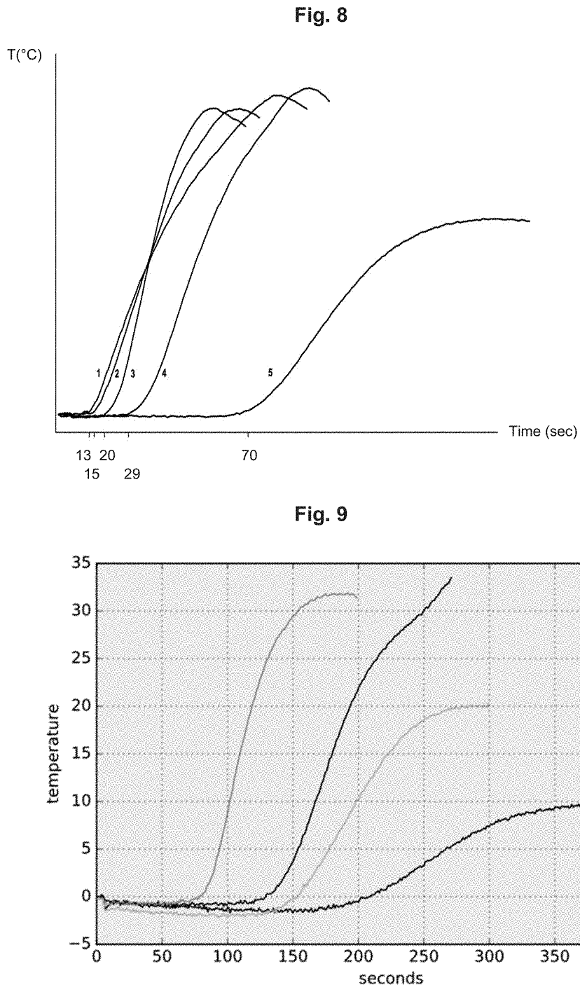

As presented in FIG. 8, the induction time increases as the concentration of acidic inhibitor increases i.e. 13 sec for the control, 15 sec for a concentration of 1% w/w, 20 sec for 5% w/w, 29 sec for 10% w/w and 70 sec for 40% w/w.

### Example 9—Printing of Three-Dimensional Articles Using a CAL Method

Tank: Cylindrical glass vial with a diameter of 15 mm

Tank rotation: Anticlockwise rotation at 120 rpm

Viscous liquid resin: Resin 3 according to table 1

Shutter: 4 mm×10 mm aperture

Light source: Spatially unmodulated single fixed source

Light exposure: 90 sec (temporal modulation)

A viscous liquid resin is loaded into the vial (i.e. tank). The vial is set into continuous rotation. When illuminated by light, the liquid resin in the center of the vial is under constant exposure of light as the vial rotates through all angles. Due to this constant exposure, in the presence of a specific level of acidic inhibitors, the threshold needed to photoinitiate polymerization and overcome the inhibition is superseded. A solid volumetric cylindrical 3D article, with a diameter of about 4 mm, is continuously produced in the center of the vial. Outside the central polymerization zone, for example, in the peripheral zones of the cylindrical vial, the liquid resin is underexposed because it is not under constant exposure but rather only exposed when it intersects the light beam on each revolution of the rotating sample. Thus, the threshold needed to initiate photopolymerization is not superseded and the acidic inhibitors present inhibit polymerization. A cylindrical object is printed in the central zone of the vat with dimensions corresponding to the aperture size (diameter 4 mm and height 10 mm).

### Example 10—Printing of Three-Dimensional Articles Using a CAL Method (Precision on the Applicability)

Tank: Cylindrical glass vial with a diameter of 18 mm

Tank rotation: Anticlockwise rotation at 12 rpm

Viscous liquid resin: Resin 5 according to table 3

TABLE 3

| Components | Resin 5 |
|---|---|
| 2-methoxyethyl cyanoacrylate | Qsp 100% |
| Polymethyl methacrylate | n/a |
| Hydrophobic fumed silica | 5.0% |
| Acylgermane Structure (VII) | 0.018% |
| R₃ = —OCH₃ “Ivocerin ®” | |
| Ferrocene | 0.001% |
| BF₃•Et₂O | 10 ppm |

Shutter/Light source: Rotating projection of a test image of a three dimensional boat according to public patent WO 2019/043529 A1 and commonly used as a test pattern in 3D printing (known as #3DBenchy The jolly 3D printing torture-test by CreativeTools.se https://3dprintingindustry.com/news/3d-benchy-torture-test-pushes-3d-printers-limit-103662/)

Light exposure: 15 sec

This example is provided to apply the principles shown in example 9 but now with combined spatial and temporal modulation of the light source. The vial (i.e. the tank) is set into continuous rotation. When illuminated by light, the liquid resin in the vial in the volumetric zone where the article is to be printed is under constant exposure as the vial rotates through all angles. Due to spatially structured exposure, in the presence of a specific level of acidic inhibitors, the threshold needed to photoinitiate polymerization and overcome the inhibition is superseded in ‘voxels’ (volume elements) corresponding to specific parts of the boat structure. A solid boat-shaped 3D article, formed within an approximate cylindrical volume of diameter of about 12 mm, is thus continuously produced. Outside the polymerization zone, for example, in the peripheral zones of the cylindrical vial, the liquid resin is not under constant exposure but rather is underexposed because such volumes only experience light when they intersect the light beam on each revolution of the rotating sample. In this way, the threshold needed to initiate photopolymerization is not superseded and the acidic inhibitors present inhibit polymerization.

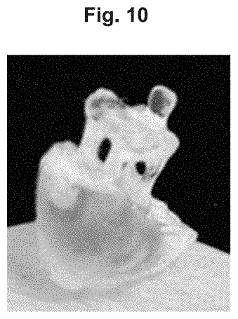

The boat-shaped 3D printed article was removed from the vial and rinsed free from any surplus resin. Finally, light from a hand-held simple LED torch was briefly passed over the boat-shaped 3D printed article to have a dry-to-touch, tack-free 3D printed hollow boat object without resort to any specialised hardware to otherwise post process. The boat-shaped 3D printed article obtained is shown on FIG. 10.

### Example 11—Inhibition of the Polymerization of a Liquid Cyanoacrylate Resin Containing an Acidic Inhibitor and a Latent Photoinhibiting System

Liquid resin: Resin 1 according to table 1

Acidic inhibitor: BF₃ etherate from Sigma Aldrich at a concentration of 35 ppm in the liquid resin

Latent inhibition system: 1-chloro-4-propoxythioxanthone (commercialized under the denomination Speedcure CPTX from Lambson) and tert-butyldiphenyliodonium hexafluorophosphate (commercialized under the denomination Speedcure 938 from Lambson), respectively at a concentration of 1% w/t and 2% w/w in the liquid resin

Initiation system: A tertiary amine (nucleophilic base)

Light source: US-VIS manicure lamp

Light wavelength (control): 435 nm

Light wavelength: 365 to 405 nm

As presented in FIG. 9, the induction time is of about 75 sec when the liquid resin is exposed to a wavelength i.e. 435 nm, at which the latent inhibition system is not photosensitive. The induction time increases as the exposure time increases i.e. 125 sec per 30 sec, 150 sec per 60 sec and 200 sec per 120 sec, when the liquid resin is exposed to wavelengths i.e. 365 to 405 nm, at which the latent inhibition system is photosensitive.

### Example 12—Photopolymerization to Print Three-Dimensional Articles Using a Photogenerated Acid Inhibitor

Liquid resin: Resin 5 according to table 4 below

TABLE 4

| Components | Resin 5 |
|---|---|
| 2-methoxyethyl cyanoacrylate | q.s. 100% |
| | (about 95.97%) |
| Speedcure 938 | 2% |
| Speedcure CPTX | 1% |
| Camphorquinone | 1% |
| Ferrocene | 300 ppm |
| BF₃•Et₂O | 10 ppm |

First light source (photopolymerization): LED with an irradiance of about 30 mW/cm² at a wavelength of 460 nm with a diameter of about 30 mm.

Second light source (photoinhibition): LED with an irradiance of about 19 mW/cm² at wavelength of 365 to 405 nm with a diameter of about 0.5 mm.

Light exposure: 45 sec

In a first experiment, a 0.5 mm-thick layer of liquid resin is poured into the tank. The first light is emitted from above the tank to induce the photopolymerization. A 500 μm-thick cylindrical 3D article is obtained.

In a second experiment, a 0.5 mm-thick layer of liquid resin is poured into the tank. The first light is emitted from above the tank for inducing the photopolymerization, while the second light is emitted from below the tank. A 500 μm-thick 3D article in the shape of a disc with a diameter of 30 mm and a 0.5 mm central hole is obtained.

### Example 13—Photopolymerization to Print Three-Dimensional Articles Using a Photogenerated Acid Inhibitor (Access to Volumes at Once Using Spatially Resolved Gradient Light Source)

Liquid resin: Resin 5 according to table 4 above

Volumetric VAT: 30×30×4 mm³ (x-axis; y-axis; z-axis (height))

First light source (photopolymerization): Spatially modulated LED with an irradiance gradient in the x-axis according to table 5 below at a wavelength of 460 nm.

Table 5: illumination gradient over y-axis

TABLE 5

| | Measured |
|---|---|
| | irradiance |
| Distance from edge | (mW/cm²) |
| 0 cm | 3.1 |
| 1 cm | 0.9 |
| 2 cm | 0.5 |
| 3 cm | 0.2 |

Second light source (photoinhibition): LED with an irradiance of about 2 mW/cm² at wavelength of 365 to 405 nm homogeneously provided throughout the VAT.

Light exposure: 45 sec

In this third experiment, a Polymer of thickness 4 mm was obtained close to the edge mostly illuminated, then a steady continuous decreasing slope of polymer is obtained until 1.2 cm (e.g. at 0.6 cm the thickness is only of 2 mm). The rest of the volume of liquid resin was photoinhibited. This demonstration follows what is proposed in the original acrylate technology (“Rapid, continuous additive manufacturing by volumetric polymerization inhibition patterning”, 2019), wherein a gradient illumination in 2 wavelength technology enable to produce nuances of the volume over the z-axis at once (when other light-based 3DPrinting technologies except CAL can be considered as n*2D iterations in the z-axis direction).

### Example 14—Printing of Three-Dimensional Articles from a Liquid Resin Comprising Cyanoacrylate and Acrylate Monomers

Liquid resin: Resins 6 and 7 according to table 4 below

TABLE 1

| Components | Resin 6 | Resin 7 |
|---|---|---|
| 2-methoxyethyl cyanoacrylate | q.s. 100% | q.s. 100% |
| | (about 79.9%) | (about 79.9%) |
| Cyclic trimethylol-propane | 20% | — |
| formal acrylate | | |
| (SR531 from Sartomer) | | |
| Dicyclopentanylmethyl acrylate | — | 20% |
| (SR789 from Sartomer) | | |
| Acylgermane Structure (VII) | 0.075% | 0.075% |
| R₃ = —OCH₃ “Ivocerin ®” | | |
| Ferrocene | 0.02% | 0.02% |
| BF₃•Et₂O | 70 ppm | 70 ppm |

Printing protocol: The same as for the first experiment of example 6, except for the platform elevation rate

Platform elevation rate (resin 6): 25 μm/sec for 1,400 sec

Platform elevation rate (resin 7): 33 μm/sec for 1,050 sec

In both experiments, solidified 3D articles are obtained.

1. A method for printing a three-dimensional article, comprising the steps of:
a) providing a volume of liquid resin comprising cyanoacrylate-based monomers, a photoinitiator and an acidic inhibitor, held in a tank, said tank comprising at least one optically transparent portion;
b) defining a polymerization zone;
c) emitting and controlling light and transmitting it to the liquid resin through the optically transparent portion for selectively polymerizing the liquid resin in the polymerization zone; and
d) obtaining a three-dimensional article made of a polymerized resin.

2. A method according to claim 1, in which the method is a layer-by-layer 3D printing method or a continuous 3D printing method.

3. A method according to claim 1, in which the cyanoacrylate-based monomers are selected from the group consisting of mono-functional cyanoacrylate monomers, multi-functional cyanoacrylate monomers including bifunctional cyanoacrylate monomers, hybrid cyanoacrylate monomers, and mixtures thereof.

4. A method according to claim 1, in which the acidic inhibitor present in the liquid resin is selected from Lewis acids, Bronsted acids or mixtures thereof.

5. A method according to claim 1, further comprising the step of providing an additional source of acidic inhibitors.

6. A method according to claim 5, in which the acidic inhibitors diffuse to the volume of liquid resin from/through the optically transparent portion.

7. A method according to claim 5, in which the acidic inhibitors diffuse to the volume of liquid resin from a separate compartment.

8. A method according to claim 5, in which the acidic inhibitors are in contact with the volume of liquid resin from a liquid or wettable, optically transparent material overlying the inner surface of the optically transparent portion of the tank.

9. A method according to claim 5, further comprising providing a resin-immiscible liquid, also held in the tank, wherein the acidic inhibitors are in contact with the liquid resin at the interface with the resin-immiscible liquid.

10. A method according to claim 5, in which an additional light, of a different wavelength than the light selectively polymerizing the liquid resin, is emitted and transmitted to the liquid resin, and in which acidic inhibitors are generated in the volume of liquid resin by the additional light.

11. A method according to claim 1, in which the liquid resin comprises, as the photoinitiator, a combination of metallocene compounds and radical photoinitiators.

12. A method according to claim 1, in which the liquid resin comprises additional photopolymerizable monomers.

13. A three-dimensional printing system comprising:
a) a volume of liquid resin comprising cyanoacrylate-based monomers, a photoinitiator and an acidic inhibitor, said volume comprising a polymerization zone;
b) a tank for holding the volume of liquid resin, said tank comprising at least one optically transparent portion;
c) a light source emitting light for selectively polymerizing the liquid resin in the polymerization zone.

14. A method according to claim 1, in which the method is a continuous 3D printing method being a continuous linear 3D printing method or a continuous volumetric 3D printing method.

15. A method according to claim 1, in which the method is selected from the group consisting of the continuous liquid interface printing method, the intelligent liquid interface method, the computed axial lithography method, the dual-wavelength volumetric photopolymerization method, and the methods derived therefrom.

16. A method according to claim 1, in which the acidic inhibitor present in the liquid resin is selected from Lewis acids.

17. A method according to claim 1, in which the acidic inhibitor present in the liquid resin is selected from the group consisting of boron trifluoride and derivatives, fluoroboric acid, sulphur dioxide, and mixtures thereof.

18. A method according to claim 1, in which the acidic inhibitor present in the liquid resin is selected from the group consisting of boron trifluoride, boron trifluoride etherate complex, boron trifluoride dihydrate complex, boron trifluoride tetrahydrofuran complex, trimethylsilyl triflate, sulphur dioxide, and mixtures thereof.

19. A method according to claim 5, in which the additional source of acidic inhibitors is selected from the group consisting of Lewis acids, Bronsted acids, acids provided from an acidic ion exchange material or in situ photogenerated acids.

20. A method according to claim 12, in which the additional photopolymerizable monomers are (meth)acrylate monomers.
